(19) United States
(12) Patent Application Publication
(10) Pub. No.: US 2025/0351217 A1
(43) Pub. Date: Nov. 13, 2025

(54) MANAGING RADIO RESOURCE CONFIGURATIONS FOR DATA COMMUNICATION IN AN INACTIVE STATE

(71) Applicant: GOOGLE LLC, Mountain View, CA (US)

(72) Inventor: Chih-Hsiang Wu, Taoyuan City (TW)

(21) Appl. No.: 18/869,136

(22) PCT Filed: May 23, 2023
(86) PCT No.: PCT/US23/67375

§ 371 Date: Nov. 25, 2024

Related U.S. Application Data
(60) Provisional application No. 63/345,015, filed on May 23, 2022.

(51) Int. Cl. H04W 76/27; H04W 76/30

(52) U.S. Cl. CPC H04W 76/27; H04W 76/30

(57) ABSTRACT

A central unit, CU, of a distributed base station that also includes a distributed unit, DU, receives (606), from the DU, i) a small data transmission, SDT, configuration related to SDT operation and ii) a non-SDT configuration related to non-SDT operation; provides (610) the SDT configuration to a UE; and ignores (609), at the CU, the non-SDT configuration.

### CROSS-REFERENCE TO RELATED APPLICATIONS

This application claims priority to and the benefit of the filing date of provisional U.S. Patent Application No. 63/345,015, titled “Managing Radio Resource Configurations for Data Communication in an Inactive State,” filed on May 23, 2022. The entire contents of the provisional application are hereby expressly incorporated herein by reference.

### FIELD OF THE DISCLOSURE

This disclosure relates generally to wireless communications and, more particularly, to communication of uplink and/or downlink data at a user equipment (UE) and a distributed unit (DU) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating in a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state using RAN-level base station coordination and RAN-level paging procedures. In some cases, the UE in the RRC_INACTIVE state has only one, relatively small packet to transmit. For situations such as these, a Small Data Transmission (SDT) procedure is used to enable the node to support data transmission for the UE operating in the RRC_INACTIVE state (i.e., without requiring that the UE transition to the RRC_CONNECTED state).

SDT is enabled on a radio bearer basis and is initiated by the UE if less than a configured amount of uplink data awaits transmission across all radio bearers for which SDT is enabled, the downlink (DL) reference signal received power (RSRP) is above a configured threshold, and a valid SDT resource is available. An SDT procedure can be initiated by the UE with either a transmission over a random access channel (RACH) (i.e., random access SDT (RA-SDT)) or over Type 1 configured grant (CG) resources (i.e., CG-SDT). For RA-SDT, the network configures 2-step and/or 4-step random access resources for SDT. In the RA-SDT, the UE transmits an initial transmission including data in a message 3 (MSG3) of a 4-step random access procedure or in a payload of a message A (MSGA) of a 2-step random access procedure. The network can then schedule subsequent uplink and/or downlink transmissions using dynamic uplink grants and downlink assignments, respectively, after completion of the random access procedure.

The CG-SDT can be initiated with valid uplink (UL) timing alignment. The UL timing alignment is maintained by the UE based on a network-configured, SDT-specific timing alignment timer and a DL RSRP of a configured number of highest ranked SSBs. Upon expiration of the SDT-specific timing alignment timer, the CG resources are released. Upon initiating the CG-SDT, the UE transmits an initial transmission including data on a CG occasion using a CG configuration, and the network can schedule subsequent uplink transmissions using dynamic grants or on future CG resource occasions. During the CG-SDT, the downlink transmissions are scheduled using dynamic assignments. The UE can initiate subsequent uplink transmission only after receiving, from the network, confirmation for the initial uplink transmission.

In some scenarios, the UE connects to a radio access network (e.g., a 5G NR RAN (NG-RAN)) that includes base stations each having a central unit (CU) and at least one distributed unit (DU). However, it is not clear how a base station including a CU and a DU should configure the UE with SDT configuration parameters to enable RA-SDT or CG-SDT.

### SUMMARY

According to the techniques of this disclosure, a CU of a base station can determine to configure or reconfigure a UE for SDT operation, e.g., when the UE is connected to the RAN and has been communicating in non-SDT operation with the base station via a DU, or when the UE is in an inactive state and has already been communicating in SDT operation with the base station via a DU. In either scenario, the CU requests an SDT DU configuration by sending a first CU-to-DU message (e.g., a UE Context Modification Request message) to a DU that is in communication with the UE, and the DU responds by sending a DU-to-CU message (e.g., a UE Context Modification Response message) that includes the SDT DU configuration and a non-SDT DU configuration. The CU first sends the DU a second CU-to-DU message that includes the SDT DU configuration, and the DU forwards the non-SDT DU configuration to the UE. For example, the CU may send the SDT configuration to the UE via the DU in an RRC release message. The CU ignores the SDT configuration.

An example embodiment of these techniques is a method implemented in a central unit (CU) of a distributed base station that also includes a distributed unit (DU), the method comprising: receiving, from the DU, (i) a small data transmission (SDT) configuration related to SDT and (ii) a non-SDT configuration related to non-SDT operation; providing the SDT configuration to a UE; and ignoring, at the CU, the non-SDT configuration,

Another example embodiment of these techniques is a radio access network (RAN) node comprising processing hardware and configured to implement a method of any of the preceding claims.

In another example, a method of handling SDT with a UE is implemented by a DU of a base station that also includes a CU. The method includes communicating, by processing hardware of the DU, with the UE in accordance with a first DU configuration, receiving, by the processing hardware and from the CU, a CU-to-DU message requesting an SDT DU configuration for the UE, and transmitting, by the processing hardware, an SDT DU configuration to the UE.

In another example, a method of handling SDT with a UE is implemented by a CU of a base station that also includes a DU. The method includes communicating, by processing hardware of the CU, with the UE via the DU and in accordance with a first CU configuration, transmitting, by the processing hardware and to the DU, a CU-to-DU message requesting an SDT DU configuration for the UE, and receiving, by the processing hardware, a DU-to-CU message including the SDT DU configuration from the DU.

In another example, a method of handling SDT with a UE is implemented by a CU of a base station that also includes a DU. The method includes communicating, by processing hardware of the CU, with the UE via the DU and in accordance with a first configuration, determining, by the processing hardware, to configure or reconfigure the UE for SDT, generating, by the processing hardware, an SDT configuration, and transmitting, by the processing hardware, the SDT configuration to the UE via the DU.

In another example, a RAN node includes processing hardware and is configured to perform any one of the methods described above.

In another example, a method of handling SDT with a base station is implemented by a UE. The method includes communicating, by processing hardware of the UE, with the base station, transmitting, by the processing hardware, a request or preference for a mode of SDT operation to the base station, and receiving, by the processing hardware, a message from the base station that causes the UE to change to the requested or preferred mode of SDT operation. In another example, a UE includes processing hardware and is configured to perform this method.

In another example, a method of handling SDT with a UE is implemented by a base station. The method includes communicating, by processing hardware of the base station, with the UE, receiving, by the processing hardware, a request or preference for a mode of SDT operation from the UE, and transmitting, by the processing hardware, a message to the UE that causes the UE to change to the requested or preferred mode of SDT operation. In another example, a base station includes processing hardware and is configured to perform this method.

In another example, a method of handling SDT with a RAN is implemented by a UE. The method includes receiving, by processing hardware of the UE, an SDT configuration from the RAN, performing, by the processing hardware, SDT with the RAN in accordance with the SDT configuration, determining, by the processing hardware, that the SDT configuration does not include one or more configuration parameters for performing at least one function, and using, by the processing hardware and while performing the SDT with the RAN, one or more other configuration parameters that are not included in the SDT configuration to perform the at least one function. In another example, a UE includes processing hardware and is configured to perform this method.

### BRIEF DESCRIPTION OF THE DRAWINGS

FIG. 1A is a block diagram of an example wireless communication system in which a user device and a base station of this disclosure can implement the techniques of this disclosure for reducing latency in data communication;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a messaging diagram of an example procedure for obtaining a non-SDT configuration for obtaining an SDT configuration for communicating data packets between the UE and the distributed base station when the radio connection between the UE and the base station is inactive;

FIG. 4 is a messaging diagram of an example procedure for communicating data packets between a UE and a distributed base station when a radio connection between the UE and the base station is inactive;

FIG. 5A is a flow diagram of an example method, implemented in the DU of FIG. 1B, for providing an SDT configuration and a non-SDT configuration to a UE via a CU;

FIG. 5B is a flow diagram of an example method similar to FIG. 5A, but in which the DU includes an indication to ignore or discard a non-SDT DU configuration in a message to the CU;

FIG. 5C is a flow diagram of an example method similar to FIG. 5A, but in which the DU includes a particular non-SDT DU configuration in a message to the CU;

FIG. 5D is a flow diagram of an example method similar to FIG. 5A, but in which the DU excludes a mandatory field for a non-SDT DU configuration in a message to the CU;

FIG. 6A is a flow diagram of an example method, implemented in the CU of FIG. 1B, for providing an SDT configuration and a non-SDT configuration to a UE;

FIG. 6B is a flow diagram of an example method similar to FIG. 6A, but in which the CU ignores or discards the non-SDT configuration;

FIG. 6C is a flow diagram of an example method similar to FIG. 6A, but in which the CU determines whether to ignore or discard the non-SDT configuration depending on whether the non-SDT DU configuration is new;

FIG. 6D is a flow diagram of an example method similar to FIG. 6A, but in which the CU determines whether to ignore or discard the non-SDT configuration depending on whether the DU provided an ignore/discard indication;

FIG. 6E is a flow diagram of an example method similar to FIG. 6A, but in which the CU chooses between a first message and a second message for the UE based on whether the DU included a non-SDT configuration in the message to the CU;

FIG. 6F is a flow diagram of an example method similar to FIG. 6A, but in which the CU chooses a second message based on whether the DU excluded a mandatory field in the message to the CU;

FIG. 7 is a flow diagram of an example method, implemented in the CU of FIG. 1B, for determining whether the CU should ignore and/or discard the non-SDT DU configuration depending on the CU-to-DU message;

FIG. 8A is a flow diagram of an example method, implemented in the CU of FIG. 1B, for determining whether to transmit a message including a DU configuration to a UE based on whether a received message includes a particular configuration;

FIG. 8B is a flow diagram of an example similar to FIG. 8A, but in which the CU determines whether the DU-to-CU message includes a particular indication;

FIG. 9A is a flow diagram of an example method, implemented in the DU of FIG. 1B, for configuring SDT and/or non-SDT communication with a UE; and

FIG. 9B is a flow diagram of an example method similar to FIG. 9A, but in DU determines whether to apply the non-SDT DU configuration based on whether the message is a release command for a UE context.

### DETAILED DESCRIPTION OF THE DRAWINGS

As discussed in more detail below, a user equipment (UE) and/or a network node of a radio access network (RAN) can use the techniques of this disclosure for managing small data communication and transitioning a UE between states of a protocol for controlling radio resources between the UE and the RAN. As used in this disclosure, small data communication can refer to small data transmission (SDT) from the perspective of the network (i.e., SDT in the downlink direction), or SDT from the perspective of the UE (i.e., SDT in the uplink direction).

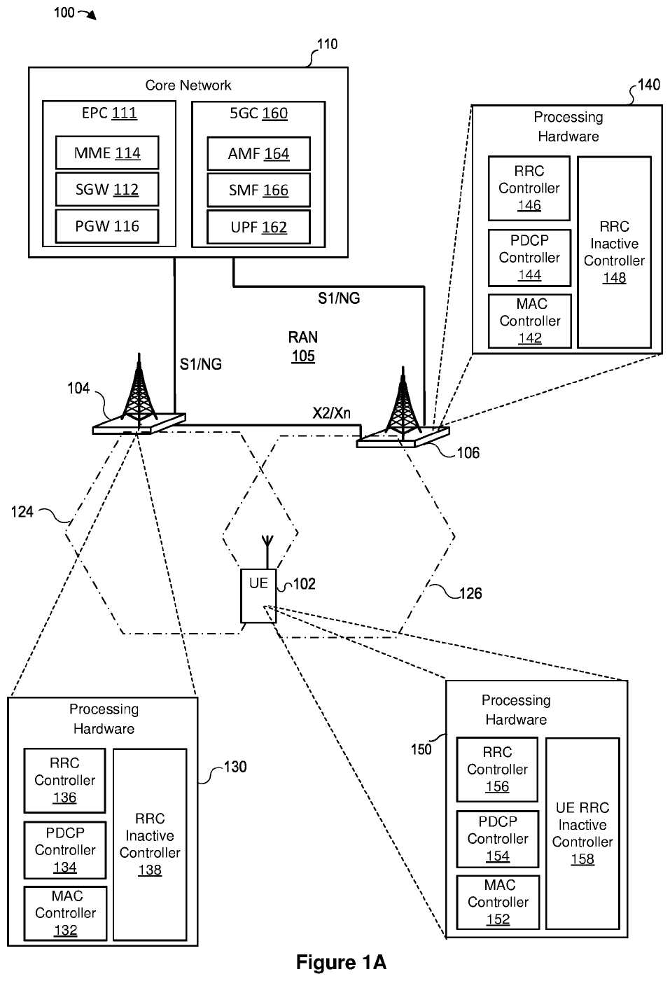

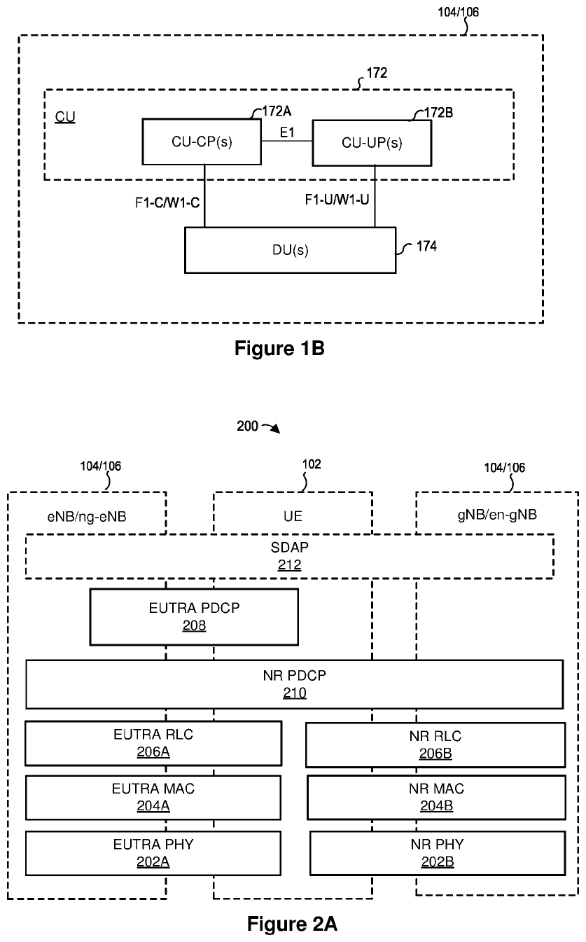

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

The CN 110 may also communicatively connect the UE 102 to an Internet Protocol (IP) Multimedia Subsystem (IMS) network 170, via the RAN 105. The IMS network 170 can provide to the UE 102 various IMS services, such as IMS short messages, IMS unstructured supplementary service data (USSD), IMS value added service data, IMS supplementary service data, IMS voice calls, and IMS video calls. To this end, an entity (e.g., a server or a group of servers) operating in the IMS network 170 supports packet exchange with the UE. The packets can convey signaling (such as session initiation protocol (SIP) messages, IP messages, or other suitable messages) as well as data (“or media”) such as voice or video.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol. As discussed below, the UE 102 in some implementations applies the techniques of this disclosure only if the size of the data (e.g., UL data) is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to an uplink (UL) data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In this latter case, the UE 102 may omit a UE ID of the UE 102 from the UL MAC PDU that does not include a UL RRC message. In yet further implementations, the UE 102 can include the UL PDCP PDU in a UL radio link control (RLC) PDU and then include the UL RLC PDU in the UL MAC PDU. In some implementation in which the UL RRC message is included in the UL MAC PDU, the UE 102 generates an RRC MAC-I and includes the RRC MAC-I in the UL RRC message. For example, the RRC MAC-I may be a resumeMAC-I field, as specified in 3GPP specification 38.331. In further implementations, the UE can obtain the RRC MAC-I from the UL RRC message with an integrity key (e.g., K_{RRCint} key), an integrity protection algorithm, and the parameters COUNT (e.g., 32-bit, 64-bit or 128-bit value), BEARER (e.g., 5-bit value) and DIRECTION (e.g., 1-bit value).

In further implementations, the data is a UL SDU of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. The UE 102 can then include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In such scenarios, the base station 106 can be referred as the “anchor” base station that sent the UE 102 into the inactive state while retaining the full UE context information. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC IDLE state can receive the DCI and scrambled CRC on the PDCCH. The UE 102 then confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction in some scenarios, and receive UL PDCP PDUs in accordance with which the base station 104 can receive data in the uplink direction in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to transmit DL PDCP PDUs in accordance with which the base station 106 can transmit data in the downlink direction in some scenarios, and receive UL PDCP PDUs in accordance with which the base station 106 can receive data in the uplink direction in other scenarios. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

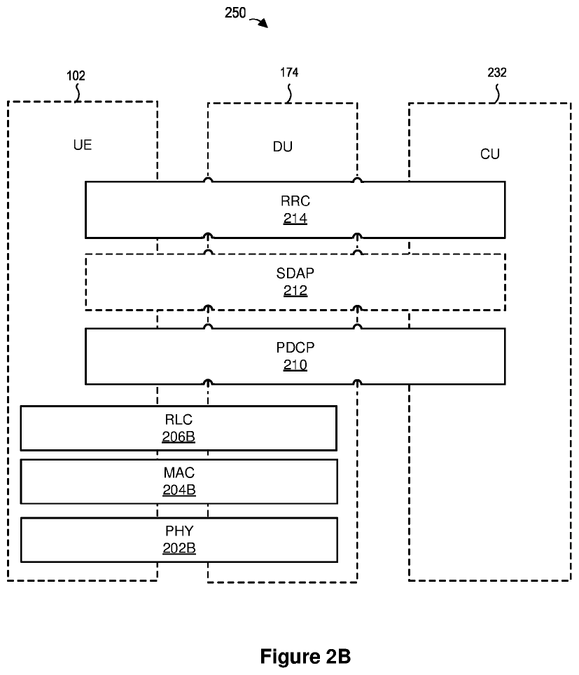

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

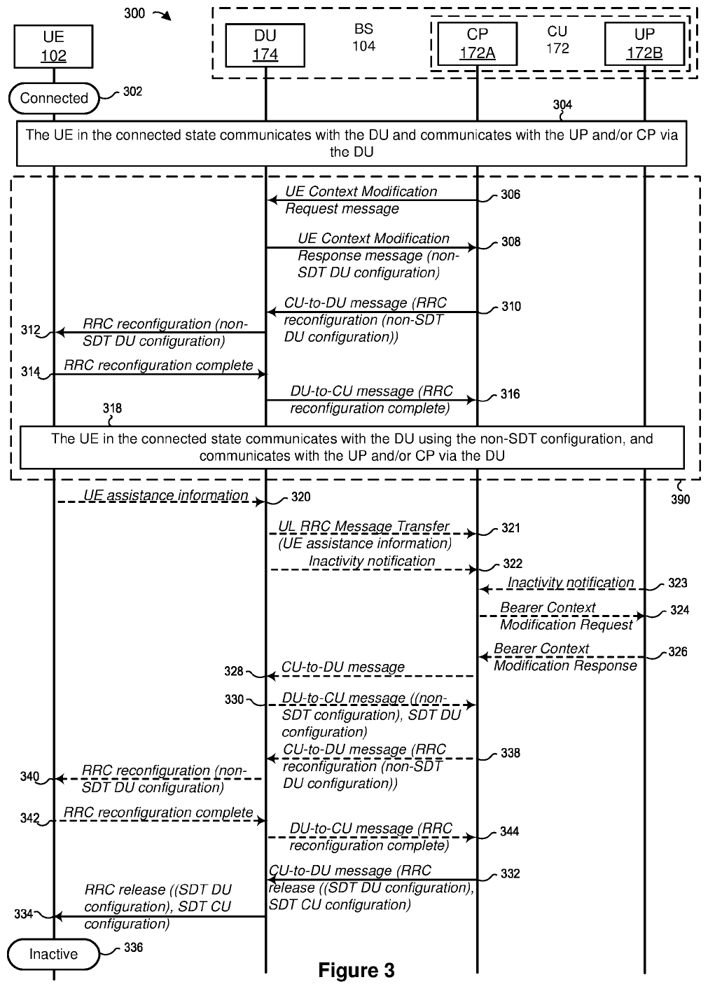

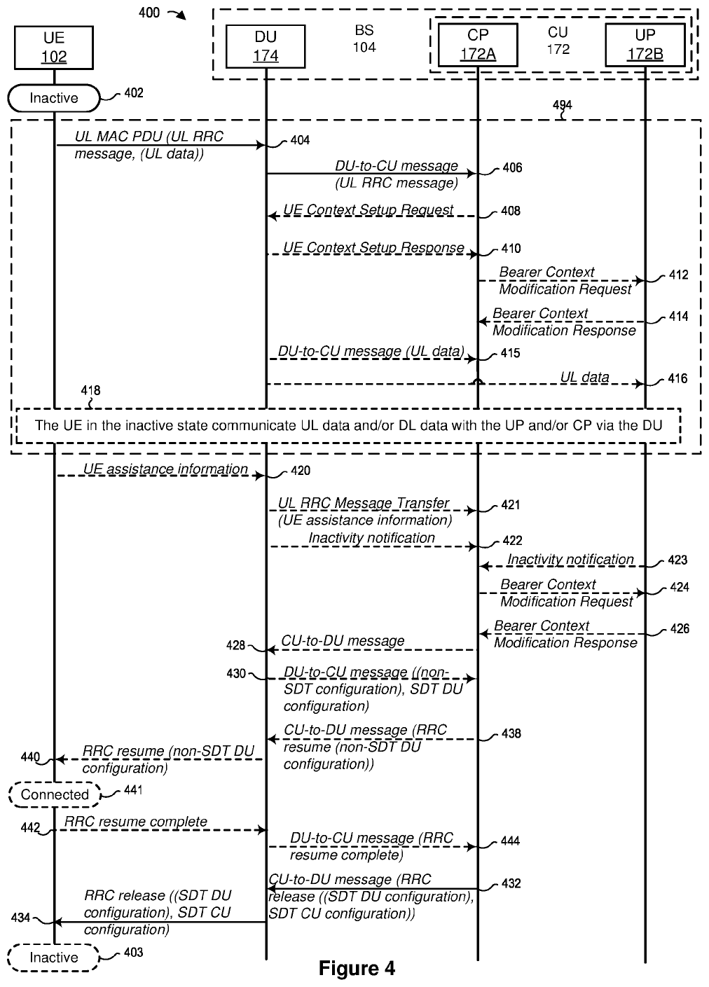

Next, several example scenarios that involve several components of FIG. 1A and relate to transmitting data in an inactive or idle state are discussed next with reference to FIGS. 3 and 4. To simplify the following description, the term “inactive state” is used and can represent the RRC_INACTIVE or RRC_IDLE state, and the “connected state” is used and can represent the RRC_CONNECTED state.

Referring first to FIG. 3, in a scenario 300, the base station 104 includes a central unit (CU) 172 and a distributed unit (DU) 174, and the CU 172 includes a CU-CP 172A and a CU-UP 172B. In this scenario 300, the UE 102 initially operates in a connected state 302 and communicates 304 with the DU 174 using a DU configuration (i.e., a first non-SDT DU configuration). The UE 102 further communicates 304 with the CU-CP 172A and/or CU-UP 172B via the DU 174 using a CU configuration (i.e., a first non-SDT CU configuration). In some implementations, while the UE 102 communicates 304 with the base station 104, the CU-CP 172A sends 306 a UE Context Modification Request message to the DU 174. In response, the DU 174 sends 308 a UE Context Modification Response message, including a non-SDT DU configuration (i.e., a second non-SDT DU configuration) for the UE 102, to the CU-CP 172A. The CU-CP 172A generates an RRC reconfiguration message including the second non-SDT DU configuration and transmits 310 a first CU-to-DU message (e.g., DL RRC Message Transfer message), including the RRC reconfiguration message, to the DU 174. In turn, the DU 174 transmits 312 the RRC reconfiguration message to the UE 102. In response, the UE 102 transmits 314 an RRC reconfiguration complete message to the DU 174, which in turn transmits 316 a first DU-to-CU message (e.g., UL RRC Message Transfer message) including the RRC reconfiguration complete message to the CU-CP 172A.

After receiving 312 the RRC reconfiguration message, the UE 102 in the connected state communicates 318 with the DU 174 using the second non-SDT DU configuration and communicates with the CU-CP 172A and/or CU-UP 172B via the DU 174. In cases where the RRC reconfiguration message does not include a CU configuration, the UE 102 communicates 318 with the CU-CP 172A and/or CU-UP 172B via the DU 174 using the first non-SDT CU configuration. In cases where the RRC reconfiguration message includes a non-SDT CU configuration (i.e., a second non-SDT CU configuration), the UE 102 communicates 318 with the CU-CP 172A and/or CU-UP 172B via the DU 174, using the second non-SDT CU configuration. In some implementations, the second non-SDT CU configuration augments the first non-SDT CU configuration or include at least one new configuration parameter not included in the first non-SDT CU configuration. In some such cases, the UE 102 and the CU-CP 172A and/or the CU-UP 172B communicate 318 with one another using the second non-SDU CU configuration and the configuration parameters in the first non-SDT CU configuration that the second non-SDU CU configuration did not augment. In some implementations, the first non-SDT CU configuration includes configuration parameters, related to operations of RRC and/or PDCP protocol layers (e.g., RRC 214 and/or NR PDCP 210), that the UE 102 and CU 172 use to communicate with one another while the UE 102 operates in the connected state. Similarly, depending on the implementation, the second non-SDT CU configuration includes configuration parameters, related to operations of the RRC and/or PDCP protocol layers, that the UE 102 and CU 172 use to communicate with one another while the UE 102 operates in the connected state. In some implementations, the first non-SDT CU configuration includes configuration parameters in a RadioBearerConfig information element (IE) and/or MeasConfig IE (e.g., as defined in 3GPP specification 38.331 v16.7.0). Similarly, the second non-SDT CU configuration includes configuration parameters in the RadioBearerConfig IE and/or MeasConfig IE (e.g., as defined in 3GPP specification 38.331 v16.7.0). In some implementations, the first non-SDT CU configuration is or includes a RadioBearerConfig IE and/or a MeasConfig IE, and the second non-SDT CU configuration is or includes a RadioBearerConfig IE and/or MeasConfig IE.

In some implementations, the second non-SDT DU configuration augments the first non-SDT DU configuration or includes at least one new configuration parameter not included in the first non-SDT DU configuration. In some such cases, the UE 102 and the DU 174 communicates 318 with one another using the second non-SDU DU configuration and the configuration parameters in the first non-SDT DU configuration that the second non-SDU DU configuration did not augment. In some implementations, the first non-SDT DU configuration includes configuration parameters, related to operations of RRC, RLC, MAC, and/or PHY protocol layers (e.g., RLC 206B, MAC 204B, and/or PHY 202B), that the UE 102 and DU 174 use to communicate with one another while the UE 102 operates in the connected state. Similarly, depending on the implementation, the second non-SDT DU configuration includes configuration parameters, related to operations of the RRC, RLC, MAC, and/or PHY protocol layers, that the UE 102 and DU 174 use to communicate with one another while the UE 102 operates in the connected state. In some implementations, the first non-SDT DU configuration includes configuration parameters in a CellGroupConfig IE (e.g., as defined in 3GPP specification 38.331 v16.7.0). Similarly, the second non-SDT DU configuration includes configuration parameters in the CellGroupConfig IE (e.g., as defined in 3GPP specification 38.331 v16.7.0). In some implementations, the first non-SDT DU configuration and the second non-SDT DU configuration are CellGroupConfig IEs.

The events 306, 308, 310, 312, 314, 316 and 318 are collectively referred to in FIG. 3 as a non-SDT resource (re) configuration procedure 390.

In some implementations, while the UE 102 communicates with the base station 104, or after the non-SDT resource (re) configuration procedure 390, the CU-CP 172A determines to cause the UE 102 to transition to an inactive state from the connected state based on data inactivity of the UE 102 (i.e., based on the UE 102 in the connected state having no data activity with the base station 104). In some implementations, while the UE 102 communicates with the base station 104 or after the non-SDT resource (re) configuration procedure 390, the UE 102 determines or detects data inactivity and transmits 320, to the DU 174, UE assistance information (e.g., a UEAssistanceInformation message) indicating that the UE 102 prefers or requests to transition to the inactive state with SDT configured. In turn, the DU 174 transmits 321 a UL RRC Message Transfer message including the UE assistance information to the CU-CP 172A. Thus, in some such implementations, the CU-CP 172A determines that the UE 102 is in a data inactivity state based on the UE assistance information. In other implementations, the DU 174 performs data inactivity monitoring for the UE 102. In further implementations, the CU-CP 172A transmits a CU-to-DU message (e.g., a UE Context Setup Request message or a UE Context Modification Request message) to the DU 174 to request or command the DU 174 to perform the data inactivity monitoring, for example. In some cases where the DU 174 detects or determines that the UE 102 is in a data inactivity state during the monitoring, the DU 174 transmits 322 an inactivity notification (e.g., a UE Inactivity Notification message) to the CU-CP 172A. Thus, in some such implementations, the CU-CP 172A determines that the UE 102 is in a data inactivity state based on the inactivity notification received from the DU 174. In yet other implementations, the CU-UP 172B performs data inactivity monitoring for the UE 102. The CU-CP 172A transmits a CP-to-UP message (e.g., a Bearer Context Setup Request message or a Bearer Context Modification Request message) to the CU-UP 172B to request or command the CU-UP 172B to perform the data inactivity monitoring, for example. In some cases where the CU-UP 172B detects or determines that the UE 102 is in a data inactivity state during the monitoring, the CU-UP 172B transmits 323 an inactivity notification (e.g., a Bearer Context Inactivity Notification message) to the CU-CP 172A. Thus, the CU-CP 172A determines that the UE 102 is in a data inactivity state based on the inactivity notification received from the CU-UP 172B. In some implementations, the CU-CP 172A determines that the UE 102 is in a data inactivity state based on any combination of the UE assistance information, the inactivity notification of the event 322, and/or the inactivity notification of the event 323.

After a certain period of data inactivity, the CU-CP 172A determines that the CU 172 and the UE 102 have not transmitted any data in the downlink direction or the uplink direction, respectively, during the certain period (e.g., using any of the techniques described above for the UE inactivity determination). In some implementations, in response to the determination, the CU-CP 172A determines to cause the UE 102 to transition to the inactive state with SDT configured. Alternatively, the CU-CP 172A determines to immediately cause the UE 102 to transition to the inactive state with SDT configured in response to determining that the UE 102 is in a data inactivity state, irrespective of whether the CU 172 has transmitted data in the downlink direction in any particular time period.

In response to or after determining that the UE 102 is in a data inactivity state (for the certain period) or otherwise in response to determining to cause the UE 102 to transition to the inactive state with SDT configured, the CU-CP 172A sends 324, to the CU-UP 172B, a Bearer Context Modification Request message to suspend data transmission for the UE 102. In response, the CU-UP 172B suspends data transmission for the UE 102 and sends 326 a Bearer Context Modification Response message to the CU-CP 172A. Also in response to or after determining that the UE 102 is in a data inactivity state (for the certain period) or otherwise in response to determining to cause the UE 102 to transition to the inactive state with SDT configured, the CU-CP 172A sends 328 a second CU-to-DU message (e.g., a UE Context Modification Request message) to instruct the DU 174 to provide (i.e., request from the DU 174) an SDT DU configuration for the UE 102. In some implementations, the CU-CP 172A includes an SDT request indication (e.g., a field, an IE, or a CG-SDT Query Indication) to request an SDT DU configuration in the second CU-to-DU message. In response to the SDT request indication or the second CU-to-DU message, the DU 174 transmits 330 a second DU-to-CU message (e.g., UE Context Modification Response message) that includes a first SDT tDU configuration to the CU-CP 172A. Alternatively, the DU 174 does not include an SDT DU configuration in the second DU-to-CU message, and the DU 174 instead sends, to the CU-CP 172A, another DU-to-CU message (e.g., UE Context Modification Required message), including the first SDT DU configuration, after receiving the second CU-to-DU message (event 328) and/or after transmitting the second DU-to-CU message (event 330). In some alternative implementations, the CU-CP 172A transmits the second CU-to-DU message and receives the second DU-to-CU message (or receives the alternative DU-to-CU message discussed above) before determining that the UE 102 is in a data inactivity state.

In some implementations, the DU 174 includes a third non-SDT DU configuration in the second DU-to-CU message. In such implementations, the CU-CP 172A generates an RRC reconfiguration message including the third non-SDT DU configuration and sends 338, to the DU 174, an additional CU-to-DU including the RRC reconfiguration message. In turn, the DU 174 transmits 340 the RRC reconfiguration message to the UE 102. In response, the UE 102 transmits 342 an RRC reconfiguration complete message to the DU 174, which in turn transmits 344 an additional DU-to-CU message (e.g., UL RRC Message Transfer message), including the RRC reconfiguration complete message, to the CU-CP 172A. In some implementations, the DU 174 includes the first SDT DU configuration in an IE (e.g., DU to CU RRC Information IE) of the second DU-to-CU message. In such implementations the DU 174 includes a non-SDT DU configuration according to a format of the IE, so that the DU 174 includes the third non-SDT DU configuration in the IE.

In some implementations, the third non-SDT DU configuration augments the first and/or second non-SDT DU configurations or includes at least one new configuration parameter not included in the first and/or second non-SDT DU configurations. In some such cases, the UE 102 in the connected state and the DU 174 communicate with one another using the third non-SDU DU configuration and the configuration parameters in the first and/or second non-SDT DU configurations that the third non-SDU DU configuration did not augment. In some implementations, the third non-SDT DU configuration includes configuration parameter(s) included in the first and/or second non-SDT DU configurations, and the DU 174 sets the configuration parameter(s) to the same value(s) in the first and/or second non-SDT DU configurations. Depending on the implementation, the DU 174 includes or does not include configuration parameter(s) to augment the first and/or second non-SDT DU configurations. Similarly, depending on the implementation, the DU 174 includes or does not include at least one new configuration parameter not included in the first and/or second non-SDT DU configurations.

In other implementations, the DU 174 includes an indication to ignore or discard the third non-SDT DU configuration in the second DU-to-CU message of event 330. In response to the indication, the CU 172 discards the third non-SDT DU configuration. Thus, the events 338, 340, 342 and 344 are omitted. For example, the indication is a non-SDT configuration ignore indication or a cell group configuration (CellGroupConfig) ignore indication.

In yet other implementations, the DU 174 generates the third non-SDT DU configuration as a particular (or “special”) non-SDT DU configuration. For example, the particular non-SDT DU configuration is an empty non-SDT DU configuration that neither (i) includes configuration parameters to augment the first and/or second non-SDT DU configurations, nor (ii) includes a new configuration parameter not included in the first and/or second non-SDT DU configurations. In some such examples, the particular non-SDT DU configuration includes a cell group ID, empty IE(s), and/or configuration parameter(s) that have been configured for the UE 102 or transmitted to the UE 102. The empty IE(s) includes no configuration parameters. In another example, the particular non-SDT DU configuration is a zero-length non-SDT DU configuration or a zero-length octet string. In some implementations, the CU 172 determines to transmit the particular non-SDT DU configuration to the UE 102 via the DU 174 at the events 338 and 340. In other implementations, the CU 172 determines to ignore or discard the particular non-SDT DU configuration. Thus, the events 338, 340, 342 and 344 are omitted.

In some implementations, the DU 174 determines to use at least one configuration parameter for the UE 102 to perform SDT, and the at least one configuration parameter is not supported by the first SDT DU configuration. In such cases, the DU 174 includes the at least one configuration parameter in the third non-SDT DU configuration. For example, the configuration parameter includes RLC bearer configuration parameter(s), logical channel configuration parameter(s), and/or MAC configuration parameter(s), and/or PHY configuration parameter(s). In some implementations, the DU 174 refrains from including MAC configuration parameter(s) and/or PHY configuration parameter(s) in the third non-SDT DU configuration.

In some implementations, the third non-SDT DU configuration includes configuration parameters in a CellGroupConfig IE (e.g., as defined in 3GPP specification 38.331 v17.0.0). In some implementations, the third non-SDT DU configuration is a CellGroupConfig IE including the configuration parameters. In some implementations, the RLC bearer configuration parameter(s) are RLC-BearerConfig IE(s) or include configuration parameter(s) in the RLC-BearerConfig IE. In some implementations, the logical channel configuration parameter(s) are LogicalChannelConfig IE(s) or include configuration parameter(s) (e.g., logicalChannelGroup, logicalChannelSR-DelayTimerApplied, and logicalChannelSR-Mask) in the LogicalChannelConfig IE. In some implementations, the MAC configuration parameter(s) are MAC-CellGroupConfig IE(s) or include configuration parameter(s) (e.g., enhancedSkipUplinkTxDynamic, SkipUplinkTxDynamic, enhancedSkipUplinkTxConfigured, buffer status reporting (BSR) configuration, and/or a power headroom reporting (PHR) configuration) in the MAC-CellGroupConfig IE. In some implementations, the PHY configuration parameters are PhysicalCellGroupConfig IE(s) or include configuration parameter(s) (e.g., a configured scheduling RNTI (CS-RNTI)) in the PhysicalCellGroupConfig IE.

In some implementations, the DU 174 refrains from including a non-SDT DU configuration (e.g., CellGroupConfig IE) in the second DU-to-CU message. Thus, the DU 174 does not include the third non-SDT DU configuration in the second DU-to-DU message. In some implementations, the DU 174 includes the first SDT DU configuration in an existing or new IE of the second DU-to-CU message instead of the IE (e.g., the DU to CU RRC Information IE) of the second DU-to-CU message. A format of the existing or new IE does not include a non-SDT DU configuration (e.g., CellGroupConfig IE), so that the DU 174 does not include a non-SDT DU configuration (e.g., CellGroupConfig IE) in the second DU-to-CU message. In other implementations, the DU 174 artificially excludes a non-SDT DU configuration (e.g., CellGroupConfig IE) from the IE (e.g., the DU to CU RRC Information IE) of the second DU-to-CU message when the DU 174 determines not to augment the first and/or second non-SDT DU configurations or not send a new non-SDT configuration parameter to the UE 102.

In some implementations, in response to determining to cause the UE 102 to transition to the inactive state with SDT configured, the CU-CP 172A generates an RRC release message (e.g., RRCRelease message or RRCConnectionRelease message) to cause the UE 102 to transition to the inactive state. In cases where the CU-CP 172A transmits 338 the RRC reconfiguration, the CU-CP 172A transmits the RRC release message after transmitting 338 the RRC reconfiguration message or receiving 344 the RRC reconfiguration complete message. In some implementations, the CU-CP 172A includes the first SDT DU configuration in the RRC release message. In further implementations, the CU-CP 172A additionally includes a first SDT CU configuration in the RRC release message. The CU-CP 172A then sends 332, to the DU 174, a third CU-to-DU message (e.g., a UE Context Release Command message or a UE Context Modification Request message) which includes the RRC release message. In turn, the DU 174 transmits 334 the RRC release message to the UE 102. In some implementations, the DU 174 receives (e.g., at event 332) a DL PDCP PDU including the RRC release message from the CU-CP 172A. The DU 174 generates a DL RLC PDU including the DL PDCP PDU, generates a DL MAC PDU including the DL RLC PDU, and transmits 334 the DL MAC PDU to the UE 102. In some implementations, the DU 174 determines that the UE 102 receives the RRC release message upon receiving a HARQ ACK for the DL MAC PDU from the UE 102. In yet other implementations, the DU 174 determines that the UE 102 receives the RRC release message upon receiving an RLC ACK for the DL RLC PDU from the UE 102. In yet other implementations, the DU 174 starts a release timer in response to transmitting or determining to transmit the RRC release message. When the release timer expires, the DU 174 determines that the UE 102 receives the RRC release message.

The RRC release message instructs the UE 102 to transition to the inactive state. The UE 102 transitions 336 to the inactive state from the connected state upon receiving the RRC release message. In some implementations, in response to or after receiving the third CU-to-DU message, the DU 174 retains the first SDT DU configuration. In some implementations, the DU 174 releases the first non-SDT DU configuration and/or second non-SDT DU configuration in response to or after receiving the third CU-to-DU message. In other implementations, the DU174 retains the first non-SDT DU configuration and/or second non-SDT DU configuration in response to or after receiving the third CU-to-DU message. In yet other implementations, the DU 174 retains a portion of the first non-SDT DU configuration and/or second non-SDT DU configuration and releases the rest of the first non-SDT DU configuration and/or second non-SDT DU configuration in response to or after receiving the third CU-to-DU message. For example, the DU 174 retains the RLC bearer configuration parameter(s), logical channel configuration parameter(s) configuration parameter(s), MAC configuration parameter(s), and/or PHY configuration parameter(s) (e.g., the CS-RNTI). In some implementations, the DU 174 sends a third DU-to-CU message (e.g., a UE Context Release Complete message or a UE Context Modification Response message) to the CU-CP 172A in response to the third CU-to-DU message.

In some implementations, the UE 102 releases at least a portion of the first non-SDT DU configuration, second non-SDT DU configuration, and/or the third non-SDT DU configuration in response to the RRC release message. In other implementations, if the RRC release message instructs the UE 102 to transition to an idle state (i.e., RRC_IDLE), the UE 102 releases the first non-SDT DU configuration, second non-SDT DU configuration, and/or third non-SDT configuration. In yet other implementations, if the RRC release message instructs the UE to transition to the inactive state (i.e., RRC_INACTIVE), the UE 102 releases a first portion of the first, second, and/or third non-SDT DU configurations and retains a second portion of the first, second, and/or third non-SDT DU configurations.

In some implementations, the CU-CP 172A does not include an indication in the third CU-to-DU message to instruct the DU 174 to retain the first SDT DU configuration, but the DU 174 nonetheless retains the first SDT DU configuration as described above. In further implementations, the CU-CP 172A includes an indication in the third CU-to-DU message to instruct the DU 174 to retain the first SDT DU configuration, and the DU 174 retains the first SDT DU configuration in response to the indication. The DU 174 retains at least a portion of the first, second, and/or non-SDT DU configurations. In such implementations, if the DU 174 receives, from the CU-CP 172A, a UE Context Release Command message for the UE 102 excluding the indication, the DU 174 releases the first SDT DU configuration and the first, second, and/or third non-SDT DU configurations.

In some implementations, the first SDT CU configuration includes a DRB list (e.g., a std-DRB-List) including a list of DRB ID(s) indicating ID(s) of DRB(s) configured for SDT. In further implementations, the first SDT CU configuration includes a SRB2 indication (e.g., sdt-SRB2-Indication) indicating a SRB2 configured for SDT. In still further implementations, the first SDT CU configuration includes a compression protocol continue indication (e.g., sdt-DRB-ContinueROHC) indicating whether a PDCP entity for the DRB(s) configured for SDT, during SDT operation (i.e., initial and/or subsequent SDT as described in FIG. 4), continues. In yet further implementations, the first SDT CU configuration includes a data volume threshold (e.g., sdt-DataVolume Threshold) for the UE 102 to determine whether SDT can be initiated.

In some implementations, the first SDT DU configuration includes at least one common SDT configuration, at least one RA-SDT configuration, and/or at least one CG-SDT configuration for CG-SDT. For example, the at least one common SDT configuration includes a buffer status reporting (BSR) configuration and/or a power headroom reporting (PHR) configuration. In another example, the at least one RA-SDT configuration includes random access configuration parameters for two-step and/or four-step random access procedures. In another example, the at least one CG-SDT configuration includes CG-SDT configuration parameters (e.g., a CS-RNTI) for CG-SDT, a configured grant (CG) configuration (e.g., ConfiguredGrantConfig IE) for CG-SDT, a time alignment timer value for CG-SDT, and/or a timing advance validity threshold. The CG configuration configures a configured grant periodically occurring in time domain (e.g., CG occasions such as slots). In some implementations, the CG configuration includes configuration parameters for frequency hopping, demodulation reference signal (DMRS), modulation and coding scheme (MCS), transport block size (TBS), resource allocation, resource block group, CG timer, frequency domain resource allocation, HARQ operation, mapping pattern, path loss reference, physical uplink shared channel (PUSCH), periodicity, power control, precoding and number of layers for multiple input multiple output (MIMO), time domain offset, and/or time domain allocation. In yet another example, the CG-SDT configuration is an SDT-MAC-PHY-CG-Config IE or include CG-SDT configuration parameters in the SDT-MAC-PHY-CG-Config IE. In some implementations, the DU 174 configures the timing advance validity threshold for the UE 102 to determine whether the UE 102 performs SDT using the configured grant configuration for CG-SDT. In further implementations, in accordance with the timing advance validity threshold, the UE 102 evaluates whether a stored timing advance value is still valid. If the UE 102 determines that the stored timing advanced value is invalid or CG-SDT is not suitable, the UE 102 performs an RA-SDT with the CU 172 via the DU 174 as described with regard to FIG. 4.

In cases where the DU 174 provides the CG-SDT configuration to the CU-CP 172A at event 330, the DU 174 retains radio resources configured by the CG-SDT configuration while retaining the first SDT DU configuration. After transmitting 330 the second DU-to-CU message, receiving 332 the third CU-to-DU message, transmitting 334 the RRC release message, receiving the HARQ ACK or RLC ACK for the RRC release message from the UE 102, or the release timer expires, the DU 174 starts or attempts to receive, from the UE 102, UL transmission(s) on radio resources configured in a configured grant (CG) configuration for SDT in the CG-SDT configuration. In some implementations, the DU 174 releases radio resources configured by the CG-SDT configuration when releasing the first SDT DU configuration or the CG-SDT configuration. In cases where the DU 174 does not provide the CG-SDT configuration to the CU-CP 172A, the DU 174 releases all related signaling and user data transport resources for the UE 102 in response to the third CU-to-DU message. In cases where the DU 174 provides the CG-SDT configuration to the CU-CP 172A, the DU 174 retains all related signaling and user data transport resources for the UE 102 in response to or after receiving the third CU-to-DU message.

In cases where the first SDT DU configuration does not include a configuration for CG-SDT, the CU-CP 172A and/or the DU 174 only configures RA-SDT for the UE 102. In some such cases, the UE 102 performs RA-SDT with the CU 172 via the DU 174 as described with regard to FIG. 4.

In some implementations, the CU-CP 172A does not request the DU 174 to provide an SDT DU configuration for causing the UE 102 to transition to the inactive state with SDT configured. In some such cases, the events 328 and 330 are omitted, and the CU-CP 172A does not include an SDT DU configuration in the RRC release message. Instead, in some such implementations, the CU-CP 172A generates the first SDT DU configuration by itself without requesting the DU 174 to provide an SDT DU configuration and includes the first SDT DU configuration in the RRC release message.

In some implementations, the DU 174 does not include an SDT DU configuration in the second DU-to-CU message (e.g., if or because the UE 102 does not support CG-SDT, the DU 174 does not support CG-SDT, or the DU 174 does not have available radio resources for CG-SDT). In some such cases, the RRC release message does not include an SDT DU configuration. Otherwise, the DU 174 includes the first SDT DU configuration as described above. In some implementations, the DU 174 does not include a CG-SDT configuration in the first SDT DU configuration in the second DU-to-CU message (e.g., if or because the UE 102 does not support CG-SDT, the DU 174 does not support CG-SDT, or the DU 174 does not have available radio resources for CG-SDT). In some such cases, the first SDT DU configuration does not include a CG-SDT configuration. Otherwise, the DU 174 includes the at least one CG-SDT configuration in the first SDT DU configuration as described above.

In some implementations, the CU-CP 172A requests the DU 174 to provide an SDT DU configuration as described above, such as in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. In some implementations, the CU-CP 172A receives a UE capability (e.g., UE-NR-Capability IE) of the UE 102 from the UE 102, the CN 110 (e.g., MME 114 or AMF 164), or the base station 106 while the UE 102 operates 302 in the connected state. The UE capability indicates whether the UE 102 supports CG-SDT. Thus, the CU-CP 172A can determine whether the UE 102 supports CG-SDT in accordance with the UE capability. In some implementations, the CU-CP 172A receives, from the DU 174, a DU-to-CU message indicating whether the DU 174 supports CG-SDT. Depending on the implementation, the DU-to-CU message is the second DU-to-CU message, the message of the event 308 or 316, or a non-UE associated message (e.g., a non-UE associated F1AP message (e.g., as defined in 3GPP specification 38.473)).

In some implementations, the DU 174 determines whether to provide an SDT DU configuration for the UE 102 to the CU-CP 172A, based on whether the UE 102 supports CG-SDT or not. In further implementations, in addition to whether the UE 102 supports CG-SDT or not, the DU 174 additionally determines whether to provide an SDT DU configuration for the UE 102 to the CU-CP 172A based on whether the DU 174 supports CG-SDT or not. In cases where the UE 102 supports CG-SDT and/or the DU 174 supports CG-SDT, the DU 174 provides the first SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the first SDT DU configuration in the second DU-to-CU message). The DU 174 receives the UE capability from the CU-CP 172A, while the UE 102 operates 302 in the connected state or in the inactive state before the event 302. Thus, the DU 174 can determine whether the UE 102 supports CG-SDT in accordance with the UE capability. In some implementations, the DU 174 sends a DU-to-CU message to the CU-CP 172A to indicate whether the DU 174 does support CG-SDT or not as described above.

Referring next to FIG. 4, a scenario 400 depicts small data transmission. In the scenario 400, the base station 104 includes a CU 172 and a DU 174. The CU 172 includes a CU-CP 172A and a CU-UP 172B. In the scenario 400, the UE 102 initially operates 402 in an inactive state with SDT configured. In some implementations or scenarios, prior to the events shown in FIG. 4, the UE 102 transitions to the inactive state with SDT configured from the connected state as described for FIG. 3 (i.e., event 402 can follow event 336). In other implementations or scenarios, prior to the events shown in FIG. 4, the UE 102 transitions to the inactive state with SDT configured from the inactive state without SDT configured. For example, the UE 102 receives, from a base station (e.g., the base station 104 or base station 106), an RRC release message, causing the UE 102 to transition to the inactive state and not including an SDT configuration. In such cases, the UE 102 transitions to the inactive state without SDT configured in response to the RRC release message. In some implementations, the UE 102 in the inactive state, with or without SDT configured, performs a RAN notification area (RNA) update with the base station without state transitions. During the RNA update, the UE 102 receives another RRC release message, including a first SDT CU configuration and/or a first SDT DU configuration from the base station, similar to the RRC release message of the event 334.

Later in time, the UE 102, operating in the inactive state with SDT configured, initiates SDT (e.g., SDT session or procedure). In response to or after initiating SDT, the UE 102 generates an initial UL MAC PDU, which includes a UL RRC message, and transmits 404 the initial UL MAC PDU to the DU 174 on the cell 124. In some implementations, the UE 102 starts an SDT session timer (e.g., timer T319a) in response to or after initiating the SDT. In some implementations, the UE 102 starts the SDT session timer upon initiating the SDT. In other implementations, the UE 102 starts the SDT session timer after transmitting 404 the initial UL MAC PDU. The DU 174 retrieves the UL RRC message from the initial UL MAC PDU, generates a first DU-to-CU message including the UL RRC message, and sends 406 the first DU-to-CU message to the CU-CP 172A. In some implementations, the first DU-to-CU message is an Initial UL RRC Message Transfer message. In other implementations, the first DU-to-CU message is a UL RRC Message Transfer message.

In scenarios in which the UE 102 initiates SDT to transmit UL data (e.g., a data packet) qualifying for SDT, the UE 102 includes the UL data in the initial UL MAC PDU that the UE 102 transmits 404. In scenarios in which the UE 102 initiates SDT to receive DL data, the UE 102 does not include an UL data packet in the initial UL MAC PDU that the UE 102 transmits 404. In further implementations, the UE 102 initiates SDT to receive DL data in response to receiving a paging from the DU 174. In some such scenarios, the UE 102 includes an SDT indication in the initial UL MAC PDU or the UL RRC message to indicate to the base station 104 that the UE 102 is initiating SDT to receive DL data.

In some implementations, the UE 102 includes a buffer status report or a power headroom report in the initial UL MAC PDU of the event 404. In other implementations, the UE 102 refrains from including a buffer status report and/or a power headroom report in the initial UL MAC PDU of the event 404 (e.g., in accordance with the BSR configuration and/or PHR configuration, respectively). Depending on the implementation, in the buffer status report, the UE 102 includes or indicates a buffer status of the UE 102 for one or more logical channels or logical channel groups. In further implementations, in the power headroom report, the UE 102 includes or indicates power headroom status or value.

In some implementations, the UE 102 in the inactive state performs a random access procedure with the DU 174 to transmit 404 the initial UL MAC PDU. In such cases, the SDT is an RA-SDT. For example, the random access procedure is a four-step random access procedure or a two-step random access procedure. In the case of the four-step random access procedure, the UE 102 transmits a random access preamble to the DU 174, and, in response, the DU 174 transmits to the UE 102 a random access response (RAR) including an uplink grant. Further, the UE 102 transmits 404 the initial UL MAC PDU in accordance with the uplink grant. The DU 174 receives 404 the initial UL MAC PDU in accordance with the uplink grant in the RAR. In the case of the two-step random access procedure, the UE 102 transmits 404 to the DU 174 a message A including a random access preamble and the initial UL MAC PDU in accordance with two-step random access configuration parameters. The UE 102 receives the two-step random access configuration parameters in system information broadcast by the DU 174 on the cell 124 before transmitting 404 the initial UL MAC PDU. The DU 174 receives 404 the initial UL MAC PDU in accordance with the two-step random access configuration parameters.

In further implementations, the UE 102 transmits 404 the initial UL MAC PDU on radio resources configured in a configured grant (CG) configuration for SDT, such as in cases where the UE 102 received a CG-SDT configuration, as described with regard to FIG. 3. Thus, the DU 174 receives 404 the UL MAC PDU on the radio resources in accordance with the CG configuration. In some such implementations, the UE 102 transmits (e.g., at event 418) subsequent UL MAC PDU(s) including one or more UL data packets, discussed below, on radio resources configured in the CG configuration.

In some implementations, if the DU 174 fails to obtain the initial UL MAC PDU at event 404, the DU 174 commands the UE 102 to retransmit the initial UL MAC PDU. More specifically, the DU 174 generates a DCI including a UL grant (i.e., dynamic grant), generates a CRC for the DCI, scrambles the CRC with an ID of the UE 102, and transmits the DCI and scrambled CRC on a PDCCH to command the UE 102 to retransmit the initial UL MAC PDU. The UE 102 receives the DCI and scrambled CRC on the PDCCH from the DU 174 and verifies whether the CRC is valid using the ID of the UE 102 and the DCI. If the UE 102 verifies that the CRC is valid using the ID of the UE 102, the UE 102 retransmits the initial UL MAC PDU to the DU 174 in accordance with the DCI. Otherwise, if the UE 102 verifies that the CRC is not valid, the UE 102 discards the DCI. In some implementations, if the DU 174 fails to obtain the initial UL MAC PDU from the retransmission of the initial UL MAC PDU, the DU 174 again commands the UE 102 to retransmit the initial UL MAC PDU in a similar manner as described above. In some implementations, the ID is a CS-RNTI. For example, the UE 102 receives the CS-RNTI from the base station 104 as described with regard to FIG. 3. In another example, the UE 102 receives an RRC resume message including the CS-RNTI from the base station 104 before initiating the SDT at event 404. In other implementations, the ID is a C-RNTI. In one implementation, the UE 102 receives an RRC reconfiguration message including the C-RNTI from the CU 172 via the base station 106 or another DU. In another implementation, the UE 102 performs a random access procedure with the DU 174 before initiating the SDT at event 404 and receives the C-RNTI from the DU 174 in a random access response or a message B (MSGB) in the random access procedure.

In some implementations, if the DU 174 successfully obtains the initial UL MAC PDU at event 404, the DU 174 commands the UE 102 to transmit or receive a new transmission. More specifically, in some such implementations, the DU 174 generates a DCI, generates a CRC for the DCI, scrambles the CRC with an ID of the UE 102, and transmits the DCI and scrambled CRC on a PDCCH to command the UE 102 to transmit or receive a new transmission. If the UE 102 receives the DCI and scrambled CRC on the PDCCH from the DU 174 and verifies that the CRC is valid using the ID of the UE 102 and the DCI, the UE 102 determines that the DU 174 successfully receives the initial UL MAC PDU. In some implementations, the UE 102 starts the SDT session timer in response to the determination. In some implementations, the DCI includes a UL grant to command the UE 102 transmit a new transmission. In such cases, the UE 102 generates a UL MAC PDU and transmits the UL MAC PDU in accordance with the DCI. In cases where the UE 102 has UL data available for transmission, the UE 102 includes UL data in the UL MAC PDU. In some such cases, the UE 102 includes or does not include MAC control element(s) and subheader(s) for the MAC control element(s), and/or padding bits and a subheader for the padding bits in the UL MAC PDU. The MAC control element(s) include a BSR and/or a PHR. In some cases where the UE 102 has no UL data available for transmission, the UE 102 only includes MAC control element(s) and subheader(s) for the MAC control element(s), and/or padding bits and/or a subheader for the padding bits in the UL MAC PDU. In other implementations, the DCI includes a DL assignment to command the UE 102 to receive a new transmission. The DU 174 generates a DL MAC PDU and transmits the DL MAC PDU as a new transmission to the UE 102 in accordance with the DL assignment. The UE 102 receives the new transmission in accordance with the DCI and obtains the DL MAC PDU from the new transmission. In cases where the DU 174 receives DL data from the CU-CP 172A or CU-CP 172B, the DU 174 includes the DL data in the DL MAC PDU. In some such cases, the DU 174 includes or does not include padding bits and/or a subheader for the padding bits in the DL MAC PDU. In some cases where the DU 174 has no DL data available for transmission, the DU 174 only includes padding bits and/or a subheader for the padding bits in the DL MAC PDU.

If the UE 102 includes UL data in the initial UL MAC PDU, the DU 174 retrieves the UL data from the initial UL MAC PDU. In some such cases, the DU 174 includes the UL data in the DU-to-CU message of the event 406. Alternatively, the DU 174 sends the UL data to the CU-CP 172A separately, in a DU-to-CU message (i.e., event 415). In some implantations, the DU-to-CU message of event 415 is a UL RRC Message Transfer message. As yet another alternative, the DU 174 sends 416 the UL data to the CU-UP 172B separately via a user-plane (UP) connection as described below (i.e., event 416). After receiving 406 the first DU-to-CU message, the CU-CP 172A in some implementations sends 408 a UE Context Setup Request message to the DU 174 to establish a UE Context of the UE 102 at the DU 174. In some implementations, in the UE Context Setup Request message, the CU-CP 172A includes transport layer information for one or more GTP-U tunnels between the CU-UP 172B and DU 174 so that the DU 174 transmits the UL data and/or subsequent UL data (e.g., in small data communication 418) via the one or more GTP-U tunnels to the CU-UP 172B. In further implementations, in response, the DU 174 sends 410 a UE Context Setup Response message to the CU-CP 172A. After receiving 406 the first DU-to-CU message, transmitting 408 the UE Context Setup Request message, and/or receiving 410 the UE Context Setup Response message, the CU-CP 172A transmits 412 to the CU-UP 172B a Bearer Context Modification Request message to resume data transmission for the UE 102. In response, the CU-UP 172B resumes data transmission for the UE 102 and transmits 414 a Bearer Context Modification Response message to the CU-CP 172A. After receiving 408 the UE Context Setup Request message and/or transmitting 410 the UE Context Setup Response message, the DU 174 transmits 415 the DU-to-CU message including the UL data to the CU-CP 172A, such as in cases where the UL data packet (received at the event 404) includes an RRC message or is associated with a SRB (e.g., SRB1 or SRB2). In some cases where the UL data packet is associated with a DRB, the DU 174 transmits 416 the UL data packet to the CU-UP 172B via one of the one or more GTP-U tunnels.

In some implementations, the CU-CP 172A includes transport layer information of the CU-UP 172B in the UE Context Setup Request message. In further implementations, the transport layer information of the CU-UP 172B includes an IP address and/or an uplink tunnel endpoint ID (e.g., TEID). Depending on the implementation, the DU 174 transmits 416 the UL data to the CU-UP 172B using the transport layer information of the CU-UP 172B. In some cases where the UE 102 has subsequent UL data to transmit (e.g., one or more UL data packets), the UE 102 transmits (at event 418) one or more subsequent UL MAC PDUs including the subsequent UL data to the DU 174. In some implementations, the UE 102 transmits the subsequent UL MAC PDU(s) to the DU 174 using the CG configuration and/or UL grant(s) (i.e., dynamical grant(s)). The DU 174 receives the subsequent UL MAC PDU(s) from the UE 102 in accordance with the CG configuration and/or UL grant(s). In turn, the DU 174 retrieves the subsequent UL data from the subsequent UL MAC PDU(s). In some implementations, the UE 102 receives (at event 418), from the DU 174, DCI(s), each including a particular UL grant of the UL grant(s). To transmit each of the DCI(s) to the UE 102, the DU 174 generates a CRC for the DCI, scrambles the CRC with an ID of the UE 102, and transmits the DCI and scrambled CRC on a PDCCH. In some implementations, the ID of the UE 102 is the C-RNTI or CS-RNTI. The UE 102 receives the DCI(s) and scrambles CRC(s) on the PDCCH(s) and transmits the subsequent UL MAC PDU(s) to the DU 174 in accordance with the DCI(s).

In some implementations, if the DU 174 fails to obtain a UL MAC PDU at event 418, the DU 174 commands the UE 102 to retransmit the UL MAC PDU. More specifically, the DU 174 generates a DCI including a UL grant (i.e., dynamic grant), generates a CRC for the DCI, scrambles the CRC with an ID of the UE 102, and transmits (at event 418) the DCI and scrambled CRC on a PDCCH to command the UE 102 to retransmit the UL MAC PDU. The UE 102 receives the DCI and scrambled CRC on the PDCCH from the DU 174 and retransmits the UL MAC PDU to the DU 174 in accordance with the UL grant or DCI. In some implementations, if the DU 174 still fails to obtain the UL MAC PDU, the DU 174 again commands the UE 102 to retransmit the UL MAC PDU in a similar manner as described above.

For each DCI and scrambled CRC that the UE 102 received at event 404 or 418, the UE 102 in some implementations verifies whether the CRC is valid using the ID of the UE 102 and the DCI. If the UE 102 verifies that the CRC is valid, the UE 102 transmits or retransmits the UL MAC PDU in accordance with the DCI. Otherwise if the UE 102 verifies that the CRC is not valid, the UE 102 discards the DCI.

In some implementations, the UE 102 includes a buffer status report or a power headroom report in the subsequent UL MAC PDU(s) (e.g., in accordance with the BSR configuration and/or PHR configuration, respectively). In some implementations, in the buffer status report, the UE 102 includes or indicates a buffer status of the UE 102 for one or more logical channels or logical channel groups. In some implementations, in the power headroom report, the UE 102 includes or indicates power headroom status or value.

In cases where the subsequent UL data is associated with one or more SRB (e.g., SRB1 and/or SRB2), the DU 174 transmits 418 the one or more DU-to-CU messages, including the subsequent UL data, to the CU-CP 172A. Depending on the implementation, each DU-to-CU message includes a particular UL data packet of the subsequent UL data. In cases where the subsequent UL data is associated with one or more DRBs, the DU 174 transmits (at event 418) the subsequent UL data to the CU-UP 172B. In some implementations, the DU 174 includes transport layer information of the DU 174 in the UE Context Setup Response message. In turn, in some implementations, the CU-CP 172A includes the transport layer information of the DU 174 in the Bearer Context Modification Request message. Depending on the implementation, the transport layer information of the DU 174 includes an IP address and/or a downlink TEID. In some cases where the CU-UP 172B receives DL data from the CN 110 or an edge server, the CU-UP 172B transmits 418 the DL data (e.g., one or more DL data packets) to the DU 174 using the transport layer information of the DU 174. In turn, the DU 174 transmits (at event 418) one or more DL MAC PDUs including the DL data to the UE 102 operating in the inactive state. In some implementations, the DU 174 transmits (at event 418) the DL MAC PDU(s) to the UE 102 using DL assignment(s). The UE 102 receives the DL MAC PDU(s) from the DU 174 in accordance with the DL assignment(s). In turn, the UE 102 retrieves the DL data from the DL MAC PDU(s). In some implementations, the UE 102 receives (at event 418), from the DU 174, DCI(s), each including a particular DL assignment of the DL assignment(s). To transmit each of the DCI(s) to the UE 102, the DU 174 generates a CRC for the DCI, scrambles the CRC with the ID of the UE 102 (e.g., the C-RNTI), and transmits the DCI and scrambled CRC on a PDCCH. The UE 102 receives the DCI(s) and scrambled CRC(s) on the PDCCH(s). The UE 102 receives DL transmission(s) from the DU 174 and obtains the DL MAC PDU(s) from the DL transmission(s).

In some implementations, if the UE 102 fails to obtain a DL MAC PDU at event 418, the UE 102 transmits a hybrid automatic repeat request (HARQ) negative acknowledgement (NACK) to the DU 174. More specifically, the DU 174 retransmits the DL MAC PDU as described below. In response to or after receiving the HARQ NACK, the DU 174 generates a DCI including a DL assignment, generates a CRC for the DCI, scrambles the CRC with an ID of the UE 102, and transmits the DCI and scrambled CRC on a PDCCH to indicate to the UE 102 to receive a retransmission of the DL MAC PDU. The UE 102 receives the DCI and scrambled CRC on the PDCCH from the DU 174 and verifies whether the CRC is valid using the ID of the UE 102 and the DCI. If the UE 102 verifies that the CRC is valid, the UE 102 attempts to receive or receives the retransmission of the DL MAC PDU in accordance with the DCI or DL assignment. Otherwise, if the UE 102 verifies that the CRC is not valid, the UE 102 discards the DCI. If the UE 102 successfully obtains the DL MAC PDU from the retransmission, the UE 102 transmits a HARQ acknowledgement (ACK) to the DU 174. Otherwise, the UE 102 transmits a HARQ NACK to the DU 174. The DU 174 then retransmits the DL MAC PDU in a similar manner as described above.

In some example scenarios, the UL data and/or DL data described above include Internet Protocol (IP) packet(s), Ethernet packet(s), or application packet(s). In other scenarios, the UL data includes PDU(s) (e.g., RRC PDU(s), PDCP PDU(s), or RLC PDU(s)) that include RRC message(s), NAS message(s), IP packet(s), Ethernet packet(s), or application packet(s).

The events 404, 406, 408, 410, 412, 414, 415, and 416 are collectively referred to in FIG. 4 as a small data transmission procedure 492.

In some implementations, the UL RRC message is an existing RRC resume request message (e.g., an RRCResumeRequest message, an RRCResumeRequest1 message, an RRCConnectionResumeRequest message, or an RRCConnectionResumeRequest1 message). In other implementations, the UL RRC message is a new RRC resume request message, similar to the existing RRC resume request message (e.g., defined in future 3GPP standards documentation). Depending on the implementation, the new RRC resume request message is a format of an existing RRC resume request message. In some implementations, in the case of the downlink SDT, the UL RRC message includes an SDT indication (e.g., a field or information element (IE) (e.g., resumeCause or ResumeCause)). In some implementations, the UL RRC message is a common control channel (CCCH) message.

In some implementations, after the UE 102 transmits 404 the UL MAC PDU or communicates 418 the subsequent UL data and/or DL data with the DU 174, the CU-CP 172A determines to stop the SDT for the UE 102 based on data inactivity of the UE 102 (i.e., the UE 102 in the inactive state has no data activity with the base station 104). For example, after the UE 102 transmits 404 the UL MAC PDU or communicates 418 the subsequent UL data and/or DL data with the DU 174, the UE 102 in the inactive determines or detects data inactivity and transmits 420, to the DU 174, UE assistance information (e.g., a UEAssistanceInformation message) indicating that the UE 102 prefers or requests to stop the SDT. In turn, the DU 174 transmits 421 a UL RRC Message Transfer message, including the UE assistance information, to the CU-CP 172A. Thus, the CU-CP 172A can determine that the UE 102 is in a data inactivity state based on the UE assistance information. In other implementations, the DU 174 performs data inactivity monitoring for the UE 102. For example, the CU-CP 172A transmits a CU-to-DU message (e.g., the UJE Context Setup Request message of the event 408 or a UJE Context Modification Request message) to the DU 174 to request or command the DU 174 to perform the data inactivity monitoring. In some cases where the DU 174 detects or determines that the UE 102 is in a data inactivity state during the monitoring, the DU 174 transmits 422 an inactivity notification (e.g., UE Inactivity Notification message) to the CU-CP 172A. Thus, the CU-CP 172A can determine that the UE 102 is in a data inactivity state based on the inactivity notification received from the DU 174. In yet other implementations, the CU-UP 172B performs data inactivity monitoring for the UE 102. For example, the CU-CP 172A transmits a CP-to-UP message to the CU-UP 172B to request or command the CU-UP 172B to perform the data inactivity monitoring. In some implementations, the CP-to-UP message is a Bearer Context Setup Request message or a Bearer Context Modification Request message before the UE 102 initiates the SDT. In other implementations, the CP-to-UP message is a Bearer Context Modification Request message during the SDT (e.g., the event 412). In cases where the CU-UP 172B detects or determines that the UE 102 is in a data inactivity state during the monitoring, the CU-UP 172B transmits 423 an inactivity notification (e.g., Bearer Context Inactivity Notification message) to the CU-CP 172A. Thus, the CU-CP 172A can determine that the UE 102 is in a data inactivity state based on the inactivity notification received from the CU-UP 172B. In some implementations, the CU-CP 172A determines that the UE 102 is in a data inactivity state based on any combination of the UE assistance information, inactivity notification of the event 422, and/or inactivity notification of the event 423.

In some implementations, after a certain period of data inactivity, the CU-CP 172A determines that neither the CU 172 nor the UE 102 has transmitted any data in the downlink direction or the uplink direction, respectively, during the certain period (e.g., using any of the techniques described above for the UE inactivity determination). In further implementations, in response to the determination, the CU-CP 172A determines to stop the SDT. Alternatively, the CU-CP 172A determines to immediately stop the SDT for the UE 102 in response to determining that the UE 102 is in a data inactivity state, irrespective of whether the CU 172 has transmitted data in the downlink direction in any particular time period.

In response to or after determining that the UE 102 is in a data inactivity state or otherwise determining to stop the SDT, the CU-CP 172A sends 424, to the CU-UP 172B, a Bearer Context Modification Request message to suspend data transmission for the UE 102. In response, the CU-UP 172B suspends data transmission for the UE 102 and sends 426 a Bearer Context Modification Response message to the CU-CP 172A. In response to or after determining that the UE 102 is in a data inactivity state or otherwise determining to stop SDT, the CU-CP 172A sends 428 a second CU-to-DU message (e.g., a UE Context Modification Request message) to instruct the DU 174 to provide (i.e., request from the DU 174) an SDT DU configuration for the UE 102. In some implementations, the CU-CP 172A includes an SDT request indication (e.g., a field or IE) to request an SDT DU configuration in the second CU-to-DU message. In response to the SDT request indication or the second CU-to-DU message, the DU 174 transmits 430 a second DU-to-CU message (e.g., UE Context Modification Response message) including a second SDT DU configuration to the CU-CP 172A. Alternatively, the DU 174 does not include an SDT DU configuration in the second DU-to-CU message, and the DU 174 instead sends to the CU-CP 172A another DU-to-CU message (e.g., UE Context Modification Required message) including the second SDT DU configuration, after receiving the second CU-to-DU message (event 428) and/or after transmitting the second DU-to-CU message (event 430). In some alternative implementations, the CU-CP 172A transmits the second CU-to-DU message and receives the second DU-to-CU message (or receives the alternative DU-to-CU message discussed above) before determining that the UE 102 is in a data inactivity state.

In some implementations, the DU 174 includes a non-SDT DU configuration in the second DU-to-CU message. In such implementations, the CU-CP 172A generates an RRC resume message, including the non-SDT DU configuration, and sends 438 to the DU 174 an additional CU-to-DU including the RRC resume message. In turn, the DU 174 transmits 440 the RRC resume message to the UE 102. In response, the UE 102 transitions 441 to a connected state and transmits 442 an RRC resume complete message to the DU 174. The DU 174 then transmits 444 an additional DU-to-CU message (e.g., UL RRC Message Transfer message) including the RRC resume complete message to the CU-CP 172A. In some implementations, the DU 174 includes the second SDT DU configuration in an IE (e.g., DU to CU RRC Information IE) of the second DU-to-CU message. In some such implementations, the DU 174 includes a non-SDT DU configuration according to a format of the IE, so that the DU 174 includes the third non-SDT DU configuration in the IE.

In some implementations, the third non-SDT DU configuration augments the first and/or second non-SDT DU configurations or includes at least one new configuration parameter not included in the first and/or second non-SDT DU configurations. In some such cases, the UE 102 in the connected state and the DU 174 communicate with one another using the third non-SDU DU configuration and the configuration parameters in the first and/or second non-SDT DU configurations that the third non-SDU DU configuration did not augment. In some implementations, the third non-SDT DU configuration includes configuration parameter(s) included in the first and/or second non-SDT DU configurations, and the DU 174 sets the configuration parameter(s) to the same value(s) in the first and/or second non-SDT DU configurations.

In other implementations, the DU 174 includes an indication to ignore or discard the third non-SDT DU configuration in the second DU-to-CU message of event 430. In response to the indication, the CU 172 discards the third non-SDT DU configuration. Thus, the events 438, 440, 441, 442, and 444 are omitted. For example, the indication is a non-SDT configuration ignore indication or a cell group configuration (CellGroupConfig) ignore indication.

In yet other implementations, the DU 174 generates the third non-SDT DU configuration as a particular non-SDT DU configuration. For example, the particular SDT DU configuration is an empty non-SDT DU configuration that neither (i) includes configuration parameters to augment the first and/or second non-SDT DU configurations, nor (ii) includes a new configuration parameter not included in the first and/or second non-SDT DU configurations. In some such examples, the particular non-SDT DU configuration includes a cell group ID and/or empty IE(s) and/or configuration parameter(s) that have been configured for the UE 102 or transmitted to the UE 102. The empty IE(s) includes no configuration parameters. In another example, the particular non-SDT DU configuration is a zero-length non-SDT DU configuration. In some implementations, the CU 172 determines to transmit the particular non-SDT DU configuration to the UE 102 via the DU 174 at the events 438 and 440. In other implementations, the CU 172 determines to ignore or discard the particular non-SDT DU configuration. Thus, the events 438, 440, 441, 442, and 444 are omitted.

In some implementations, the DU 174 determines to use at least one configuration parameter for the UE 102 to perform SDT and the at least one configuration parameter is not supported by the second SDT DU configuration. In such cases, the DU 174 includes the at least one configuration parameter in the third non-SDT DU configuration. For example, the at least configuration parameter includes RLC bearer configuration parameter(s), logical channel configuration parameter(s), MAC configuration parameter(s), and/or PHY configuration parameter(s). In some implementations, the DU 174 refrains from including MAC configuration parameter(s) and/or PHY configuration parameter(s) in the third non-SDT DU configuration.

In some implementations, the third non-SDT DU configuration includes configuration parameters in a CellGroupConfig IE (e.g., as defined in 3GPP specification 38.331 v17.0.0). In some implementations, the third non-SDT DU configuration is a CellGroupConfig IE including the configuration parameters. In some implementations, the RLC bearer configuration parameter(s) are RLC-BearerConfig IE(s) or include configuration parameter(s) in the RLC-BearerConfig IE. In some implementations, the logical channel configuration parameter(s) are LogicalChannelConfig IE(s) or include configuration parameter(s) (e.g., logicalChannelGroup, logicalChannelSR-DelayTimerApplied, and logicalChannelSR-Mask) in the LogicalChannelConfig IE. In some implementations, the MAC configuration parameter(s) are MAC-CellGroupConfig IE(s) or include configuration parameter(s) (e.g., enhancedSkipUplinkTxDynamic, SkipUplinkTxDynamic, enhancedSkipUplinkTxConfigured, buffer status reporting (BSR) configuration and/or a power headroom reporting (PHR) configuration) in the MAC-CellGroupConfig IE. In some implementations, the PHY configuration parameters are PhysicalCellGroupConfig IE(s) or include configuration parameter(s) (e.g., a configured scheduling RNTI (CS-RNTI)) in the PhysicalCellGroupConfig IE.

In some implementations, the DU 174 refrains from including a non-SDT DU configuration (e.g., CellGroupConfig IE) in the second DU-to-CU message. In some implementations, the DU 174 includes the first SDT DU configuration in an existing or new IE of the second DU-to-CU message instead of the IE (e.g., the DU to CU RRC Information IE) of the second DU-to-CU message. A format of the existing or new IE does not include a non-SDT DU configuration (e.g., CellGroupConfig IE), so that the DU 174 does not include a non-SDT DU configuration (e.g., CellGroupConfig IE) in the second DU-to-CU message. In other implementations, the DU 174 artificially excludes a non-SDT DU configuration (e.g., CellGroupConfig IE) from the IE (e.g., the DU to CU RRC Information IE) of the second DU-to-CU message when the DU 174 determines not to augment the first and/or second non-SDT DU configurations or not send a new non-SDT configuration parameter to the UE 102.

In some implementations, in response to determining to stop the SDT, the CU-CP 172A generates an RRC release message (e.g., RRCRelease message or RRCConnectionRelease message) to stop the SDT and cause the UE 102 to remain in the inactive state. In some implementations, the CU-CP 172A includes the SDT DU configuration and an SDT CU configuration in the RRC release message. The CU-CP 172A then sends 432 to the DU 174 a third CU-to-DU message (e.g., a UE Context Release Command message or a UE Context Modification Request message) that includes the RRC release message. In turn, the DU 174 transmits 434 the RRC release message to the UE 102. The UE 102 stops the SDT (i.e., determines that the SDT session or procedure ends or terminated) and remains in the inactive state upon receiving the RRC release message. In some implementations, in response to or after stopping the SDT, the UE 102 stops the SDT session timer, stops monitoring a PDCCH for SDT, and/or releases a C-RNTI that the UE 102 uses to monitor a PDCCH for SDT. Alternatively, the UE 102 retains the C-RNTI. In further implementations, in response to the third CU-to-DU message, the DU 174 retains the SDT DU configuration and releases or does not release the first non-SDT DU configuration and/or second non-SDT DU configuration, as discussed above in connection with FIG. 3. The DU 174, depending on the implementation, sends a third DU-to-CU message (e.g., a UE Context Release Complete message or a UE Context Modification Response message) to the CU-CP 172A in response to the third CU-to-DU message. In some implementations, if the RRC release message instructs the UE 102 to transition to an idle state (i.e., RRC_IDLE), the UE 102 transitions to the RRC IDLE and releases a non-SDT configuration (e.g., the first non-SDT DU configuration, first non-SDT CU configuration, second non-SDT DU configuration, and/or second non-SDT CU configuration described for FIG. 3) and at least one SDT configuration (e.g., the first SDT DU configuration and/or first SDT CU configuration described for FIG. 3).

Examples and implementations discussed above for events 320, 321, 322, 323, 324, 326, 328, 330, 338, 340, 342, 344, 332, 334 can apply to events 420, 421, 422, 423, 424, 426, 428, 430, 438, 440, 442, 444, 432, 434, respectively. In some implementations, after stopping the SDT, the UE 102 performs another small data transmission procedure with the base station 104 or base station 106, similar to the procedure 494.

In some implementations, the CU-CP 172A does not request the DU 174 to provide an SDT DU configuration to stop SDT and cause the UE 102 to transition to the inactive state with SDT configured (e.g., RA-SDT). In some such cases, the events 428 and 430 are omitted. In such cases, the CU-CP 172A does not include an SDT DU configuration in the RRC release message. Alternatively, the CU-CP 172A generates the second SDT DU configuration by itself and includes the second SDT DU configuration in the RRC release message.

In some implementations, the DU 174 does not include an SDT DU configuration in the second DU-to-CU message (e.g., if or because the UE 102 does not support CG-SDT, the DU 174 does not support CG-SDT, or the DU 174 does not have available radio resources for CG-SDT). In some such cases, the RRC release message does not include an SDT DU configuration. Otherwise, the DU 174 includes the second SDT DU configuration as described above. In some implementations, the DU 174 does not include a CG-SDT configuration in the second SDT DU configuration in the second DU-to-CU message (e.g., if or because the UE 102 does not support CG-SDT, the DU 174 does not support CG-SDT, or the DU 174 does not have available radio resources for CG-SDT). In some such cases, the second SDT DU configuration does not include a CG-SDT configuration. Otherwise, the DU 174 includes the at least one CG-SDT configuration in the second SDT DU configuration as described above.

In some implementations, the CU-CP 172A requests the DU 174 to provide an SDT DU configuration as described above, such as in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. In some implementations, the CU-CP 172A receives a UE capability (e.g., UE-NR-Capability IE) of the UE 102 from the UE 102, the CN 110 (e.g., MME 114 or AMF 164), or the base station 106 before the UE 102 initiates the SDT, while the UE 102 operates 402 in the inactive state, while the UE 102 performs the SDT (e.g., in the UE Context Setup Request message of the event 408 or the CU-to-DU message of the event 428), or while the UE 102 operates in the connected state, as described for FIG. 3. The UE capability indicates whether the UE 102 supports CG-SDT. Thus, the CU-CP 172A can determine whether the UE 102 supports CG-SDT in accordance with the UE capability. In some implementations, the CU-CP 172A receives, from the DU 174, a DU-to-CU message indicating whether the DU 174 supports CG-SDT. Depending on the implementation, the DU-to-CU message is the second DU-to-CU message, the message of the event 308 or 316, or a non-UE associated message (e.g., a non-UE associated F1AP message (e.g., as defined in 3GPP specification 38.473)).

In some implementations, the DU 174 determines whether to provide an SDT DU configuration for the UE 102 to the CU-CP 172A, based on whether the UE 102 supports CG-SDT or not. In further implementations, in addition to whether the UE 102 supports CG-SDT or not, the DU 174 additionally determines whether to provide an SDT DU configuration for the UE 102 to the CU-CP 172A based on whether the DU 174 supports CG-SDT or not. In cases where the UE 102 supports CG-SDT and/or the DU 174 supports or enables CG-SDT, the DU 174 provides the second SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the second SDT DU configuration in the second DU-to-CU message). In some implementations, the DU 174 receives the UE capability from the CU-CP 172A, e.g., while the UE 102 operates in the connected state or in the inactive state. Thus, the DU 174 can determine whether the UE 102 supports CG-SDT in accordance with the UE capability. In some implementations, the DU 174 sends a DU-to-CU message to the CU-CP 172A to indicate whether the DU 174 supports CG-SDT, as described above.

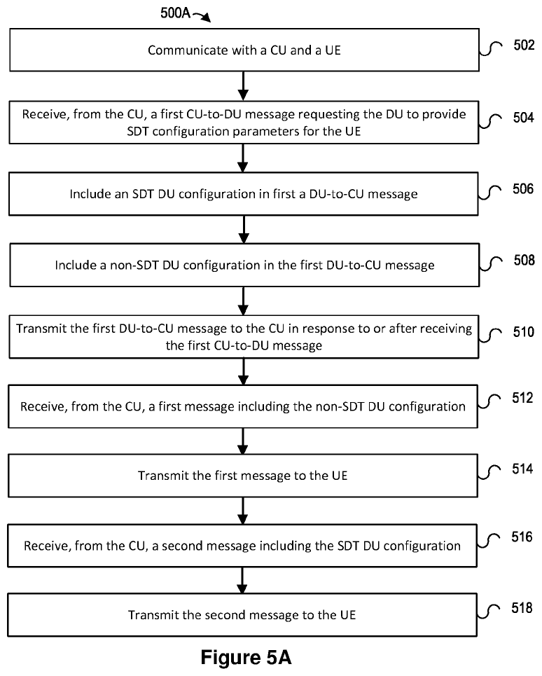

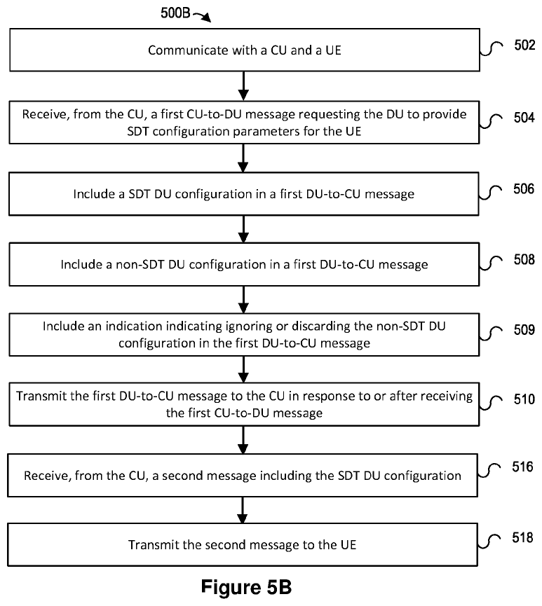

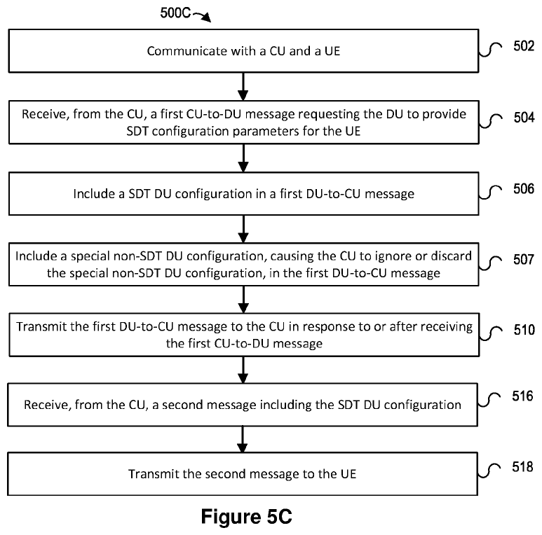

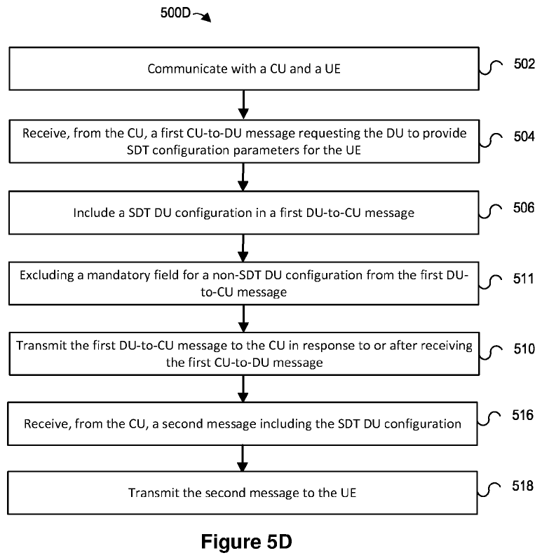

Next, several example methods that can be implemented in a UE; in one or more base stations, DUs, or CUs; or in a RAN to support data communications in the inactive state are discussed next with reference to FIGS. 5A-9B.

FIG. 5A illustrates a method 500A, implemented by a DU (e.g., the DU 174), for providing SDT configuration parameters to a UE (e.g., the UE 102) via a CU (e.g., the CU 172 or the CU-CP 172A).

The method 500A begins at block 502, where the DU communicates with the CU and the UE (e.g., events 304, 306, 318, 310, 312, 316, 314, 318, 390, 320, 321, 322, 404, 406, 408, 410, 415, 416, 418, 494, 420, 421, 422 of FIGS. 3 and 4). At block 504, the DU receives, from the CU, a first CU-to-DU message requesting the DU to provide SDT configuration parameters (e.g., events 328, 428 of FIGS. 3 and 4). At block 506, the DU includes an SDT DU configuration in a first DU-to-CU message (e.g., event 330, 430 of FIGS. 3 and 4). At block 508, the DU includes a non-SDT DU configuration in the first DU-to-CU message (e.g., event 330, 430 of FIGS. 3 and 4). At block 510, the DU transmits the first DU-to-CU message to the CU in response to or after receiving the CU-to-DU message (e.g., events 330, 430 of FIGS. 3 and 4). At block 512, the DU receives, from the CU, a first message including the non-SDT DU configuration (e.g., events 338, 438 of FIGS. 3 and 4). At block 514, the DU transmits the first message to the UE (e.g., events 340, 440 of FIGS. 3 and 4). At block 516, the DU receives, from the CU, a second message including the SDT DU configuration (e.g., events 334, 434 of FIGS. 3 and 4). At block 518, the DU transmits the second message to the UE (e.g., events 336, 436 of FIGS. 3 and 4).

In some implementations, the first CU-to-DU message is a UE Context Modification Request message. In some implementations, the first DU-to-CU message is a UE Context Modification Response message. In other implementations, the first DU-to-CU message is a UE Context Modification Required message. In some such cases, the DU transmits a second DU-to-CU message (e.g., UE Context Modification Response message) to the CU in response to the first CU-to-DU message, and the CU transmits a second CU-to-DU message (e.g., UE Context Modification Confirm message) to the DU in response to the first DU-to-CU message.

In some implementations, the DU communicates with the UE operating in an inactive state, using the SDT DU configuration and/or non-SDT DU configuration. In some implementations, the DU includes a CS-RNTI and CG-SDT configuration parameters in the SDT DU configuration. In some implementations, the DU includes RLC bearer configuration parameter(s), logical channel configuration parameter(s), MAC configuration parameter(s), and/or PHY configuration parameter(s) in the non-SDT DU configuration. The DU communicates with the UE operating in the inactive state, using the CS-RNTI and CG-SDT configuration parameters. Alternatively, the DU includes the CS-RNTI in the non-SDT DU configuration. Examples and implementations of the configuration parameters are as described above.

In some implementations, after transmitting the first message, the DU receives a third message from the UE (e.g., event 342, 442 of FIGS. 3 and 4) and transmits an additional DU-to-CU message including the third message to the CU (e.g., event 344, 444). In some implementations, the first message and third message are an RRC reconfiguration message and an RRC reconfiguration complete message, respectively. In other implementations, the first message and third message are an RRC resume message and an RRC resume complete message, respectively. In some implementations, the DU transmits the second message after transmitting the first message or receiving the third message. In some implementations, the second message is an RRC release message.

In some implementations, the first CU-to-DU message includes an SDT request indication (e.g., CG-SDT Query Indication). In response to the SDT request indication, the DU includes the SDT DU configuration in the first DU-to-CU message.

FIG. 5B is a flow diagram of an example method 500B similar to the method 500A, except that method 500B includes block 509 instead of blocks 512 and 514. At block 509, the DU includes an indication to ignore or discard the non-SDT DU configuration in the first DU-to-CU message. The CU ignores or discards the non-SDT DU configuration in response to the indication. In some examples, the indication is a non-SDT configuration ignore indication or a cell group configuration (CellGroupConfig) ignore indication.

FIG. 5C is a flow diagram of an example method 500B similar to the methods 500A and 500B, except that method 500C includes block 507 instead of block 509, 512, and 514. At block 507, the DU includes a particular non-SDT DU configuration in the first DU-to-CU message (e.g., event 340, 430 of FIGS. 3 and 4), causing the CU 172 to ignore or discard the special non-SDT DU configuration. In some implementations, the CU ignores or discards the special non-SDT DU configuration in response to receiving the particular non-SDT DU configuration. Examples and implementations of the particular non-SDT DU configuration are as described above.

FIG. 5D is a flow diagram of an example method 500D similar to the methods 500A, 500B, and 500C, except that method 500D includes block 511 instead of block 507, 509, 512, and 514. At block 511, the DU excludes a mandatory field for a non-SDT DU configuration from the first DU-to-CU message. In some implementations, the non-SDT DU configuration is a CellGroupConfig IE.

Examples and implementations described for FIGS. 3 and 4 can apply to FIGS. 5A-5D.

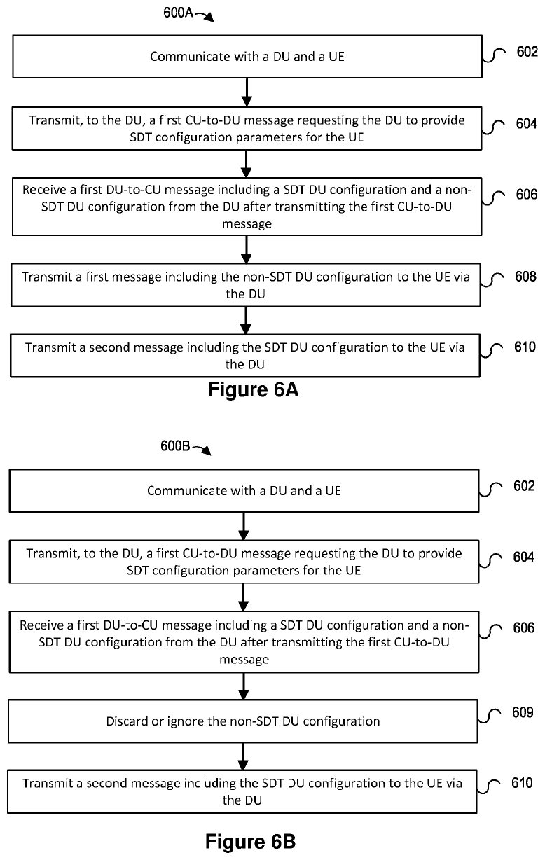

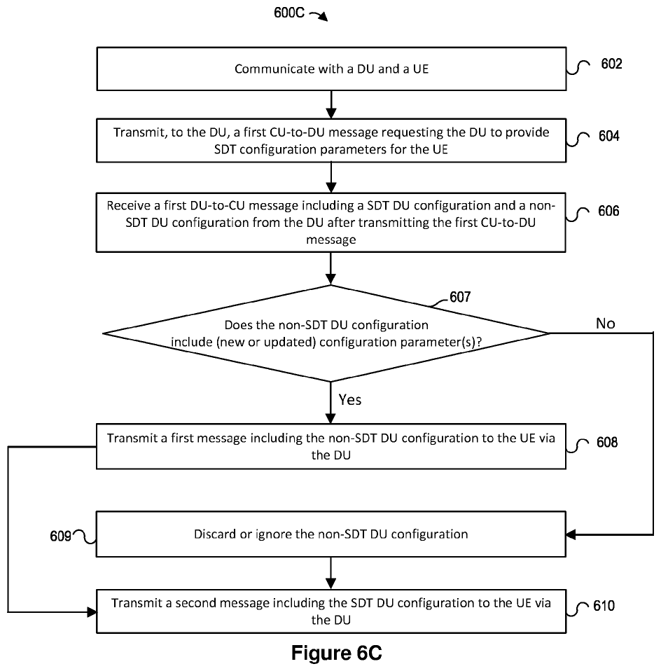

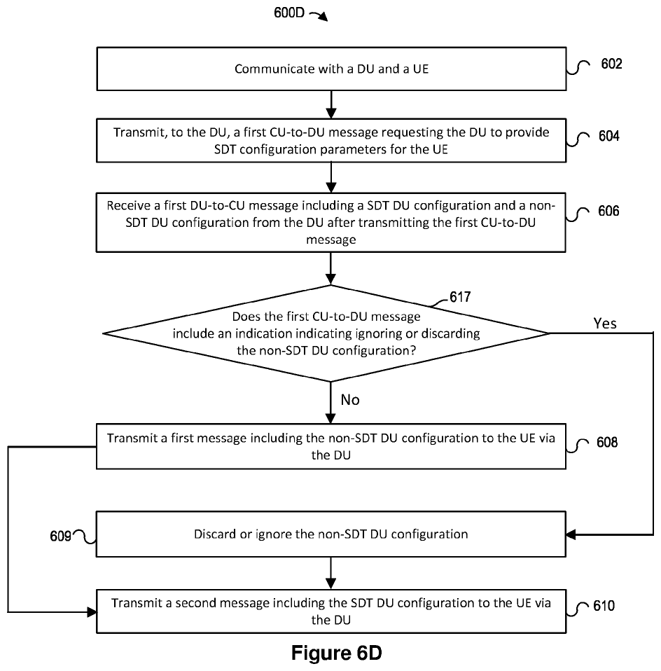

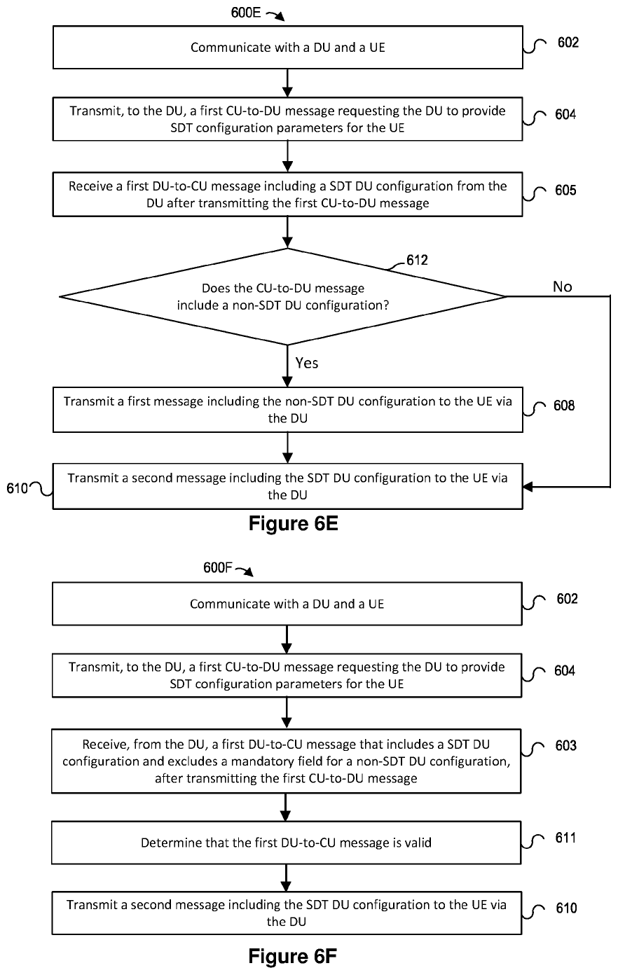

FIG. 6A illustrates a method 600A, implemented by a CU (e.g., the CU 172 or CU-CP 172A), for providing SDT configuration parameters to a UE (e.g., the UE 102) via a DU (e.g., the DU 174).

The method 600A begins at block 602, where the CU communicates with the DU and UE (e.g., events 304, 306, 318, 310, 312, 316, 314, 318, 390, 320, 321, 322, 404, 406, 408, 410, 415, 416, 418, 494, 420, 421, 422 of FIGS. 3 and 4). At block 604, the CU transmits, to the DU, a first CU-to-DU message requesting the DU to provide configuration parameters for SDT in response to the determination (e.g., events 328, 428 of FIGS. 3 and 4). At block 606, the CU receives a first DU-to-CU message, including an SDT DU configuration and a non-SDT configuration, from the DU after transmitting the first CU-to-DU message (e.g., events 330, 430 of FIGS. 3 and 4). At block 608, the CU transmits a first message including the non-SDT configuration to the UE via the DU (e.g., events 338, 340, 438, 440 of FIGS. 3 and 4). At block 610, the CU transmits a second message including the non-SDT configuration to the UE via the DU (e.g., events 332, 334, 432, 434).

FIG. 6B is a flow diagram of an example method 600B similar to the method 600A, except that method 600B includes block 609 instead of block 608. At block 609, the CU discards or ignores the non-SDT DU configuration. Thus, the CU does not transmit the non-SDT DU configuration to the DU and/or UE. In some implementations, the first DU-to-CU includes an indication to ignore or discard the non-SDT DU configuration, as described for FIG. 5B. The CU ignores or discards the non-SDT DU configuration in response to the indication. In other implementations, the non-SDT DU configuration is a particular non-SDT DU configuration, as described for FIG. 5C. Thus, the CU ignores or discards the non-SDT DU configuration in response to receiving the particular non-SDT DU configuration.

FIG. 6C is a flow diagram of an example method 600C similar to the methods 600A and 600B, except that method 600C includes block 607. At block 607, the CU determines whether the non-SDT DU configuration includes (new or updated) configuration parameter(s). If the CU determines that the non-SDU DU configuration includes (new or updated) configuration parameter(s), the flow proceeds to block 608. Otherwise, if the non-SDT DU configuration does not include (new or updated) configuration parameter(s), the flow proceeds to block 609. In some examples, the non-SDT DU configuration is a particular non-SDT DU configuration. In another example, the non-SDT DU configuration includes configuration parameter(s) that have been configured for the UE or transmitted to the UE.

FIG. 6D is a flow diagram of an example method 600D similar to the methods 600A, 600B, and 600C, except that method 600D includes block 617 instead of block 607. At block 617, the CU determines whether the first DU-to-CU message includes an indication to ignore or discard the non-SDT configuration. If the CU determines that the first DU-to-CU message does not include the indication, the flow proceeds to block 608. Otherwise, if the first DU-to-CU message includes the indication, the flow proceeds to block 609. In some examples, the indication is a non-SDT configuration ignore indication or a cell group configuration (CellGroupConfig) ignore indication.

FIG. 6E is a flow diagram of an example method 600E similar to the method 600A, except that the method 600E includes blocks 605 and 612 instead of block 606. At block 605, the CU receives a first DU-to-CU message, including an SDT DU configuration, from the DU after transmitting the first CU-to-DU message (e.g., events 330, 430 of FIGS. 3 and 4). At block 612, the CU determines whether the first DU-to-CU message includes a non-SDT DU configuration. If the CU determines that the first DU-to-CU message includes a non-SDT DU configuration, the flow proceeds to blocks 608 and 610. Otherwise, if the CU determines that the first DU-to-CU message does not include a non-SDT DU configuration, the flow proceeds to block 610.

FIG. 6F is a flow diagram of an example method 600F similar to the method 600A, except that the method 600F includes blocks 603 and 611 instead of blocks 606 and 608. At block 603, the CU receives, from the DU, a first DU-to-CU message that includes an SDT DU configuration and excludes a mandatory field for a non-SDT DU configuration after transmitting the first CU-to-DU message. At block 611, the CU determines that the first DU-to-CU message is valid. In response to the determination, the CU retrieves the SDT DU configuration from the first DU-to-CU message and generates the second message including the SDT DU configuration.

Examples and implementations described for FIGS. 3, 4, and 5A-5D can apply to FIGS. 6A-6F.

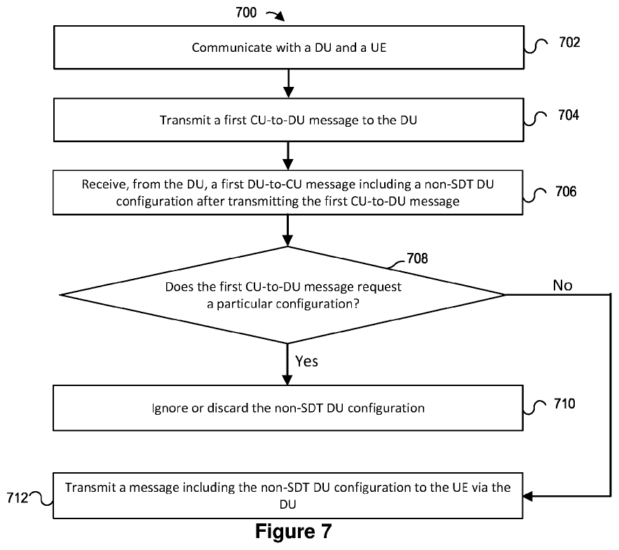

FIG. 7 illustrates a method 700, implemented by a CU (e.g., the CU 172 or CU-CP 172A), for requesting SDT configuration parameters for a UE (e.g., the UE 102) from a DU (e.g., the DU 174).

The method 700 begins at block 702, where the CU communicates with the DU and UE (e.g., events 304, 306, 318, 310, 312, 316, 314, 318, 390, 320, 321, 322, 404, 406, 408, 410, 415, 416, 418, 494, 420, 421, 422 of FIGS. 3 and 4). At block 704, the CU transmits a first CU-to-DU message to the DU. At block 706, the CU receives, from the DU, a first DU-to-CU message (e.g., events 308, 330, 410, 430 of FIGS. 3 and 4). At block 708, the CU determines whether the first CU-to-DU message requests a particular configuration. In some examples, the particular configuration is an SDT DU configuration (e.g., SDT-MAC-PHY-CG-Config IE). When the CU determines that the DU-to-CU message requests the particular configuration, the flow proceeds to block 710. At block 710, the CU ignores or discards the non-SDT DU configuration. Otherwise, when the CU determines that the first CU-to-DU message does not request the particular configuration, the flow proceeds to block 712. At block 712, the CU transmits a message, including the non-SDT DU configuration, to the UE via the DU (e.g., events 338, 340, 438, 440 of FIGS. 3 and 4).

Examples and implementations described for FIGS. 3, 4, 5A-5D, and 6A-6F can apply to FIG. 7.

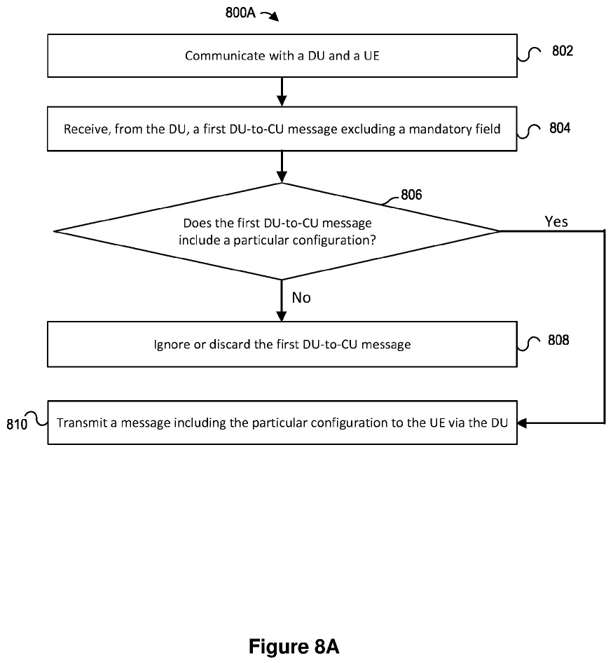

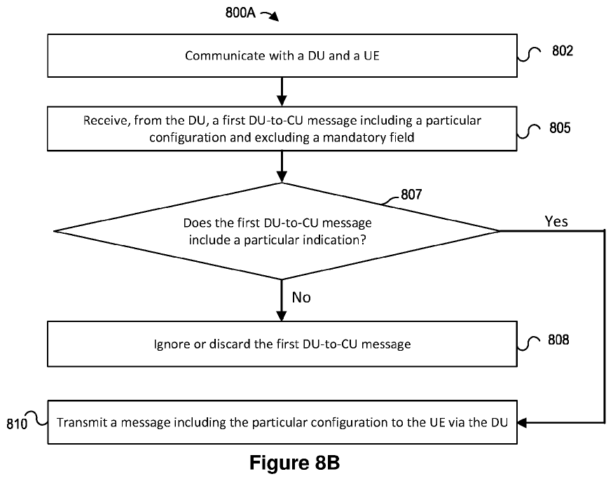

FIG. 8A illustrates a method 800A, implemented by a CU (e.g., the CU 172 or CU-CP 172A), for requesting SDT configuration parameters for a UE (e.g., the UE 102) from a DU (e.g., the DU 174).

The method 800A begins at block 802, where the CU communicates with the DU and UE (e.g., events 304, 306, 318, 310, 312, 316, 314, 318, 390, 320, 321, 322, 404, 406, 408, 410, 415, 416, 418, 494, 420, 421, 422 of FIGS. 3 and 4). At block 804, the CU receives, from the DU, a first DU-to-CU message excluding a mandatory field (e.g., events 308, 330, 410, 430 of FIGS. 3 and 4). At block 806, the CU determines whether the first DU-to-CU message includes a particular configuration. In some examples, the particular configuration is an SDT DU configuration. In other examples, the particular configuration is a positioning configuration. When the CU determines that the first DU-to-CU message does not include the particular configuration, the flow proceeds to block 808. At block 808, the CU ignores or discards the first DU-to-CU message. Otherwise, when the CU determines that the first DU-to-CU message includes the particular configuration, the flow proceeds to block 810. At block 810, the CU transmits a message including the particular configuration to the UE via the DU (e.g., events 338, 340, 438, 440 of FIGS. 3 and 4).

In some implementations, the mandatory field includes or identifies a non-SDT DU configuration (e.g., a CellGroupConfig IE).

FIG. 8B is a flow diagram of an example method 800B similar to the method 800A, except that method 800B includes blocks 805 and 807 instead of block 806. At block 805, the CU receives, from the DU, a first DU-to-CU message including a particular configuration and excluding a mandatory field (e.g., events 308, 330, 410, 430). At block 807, the CU determines whether the first DU-to-CU message includes a particular indication. In some implementations, the particular indication is an indication to ignore or discard the mandatory field. When the CU determines that the first DU-to-CU message includes the particular indication, the flow proceeds to block 808. Otherwise, when the CU determines that the first DU-to-CU message does not include the particular indication, the flow proceeds to block 810.

In some implementations, the particular indication is a non-SDT configuration ignore indication or a cell group configuration (CellGroupConfig) ignore indication.

Examples and implementations described for FIGS. 3, 4, 5A-5D, 6A-6F, and 7 can apply to FIGS. 8A and 8B.

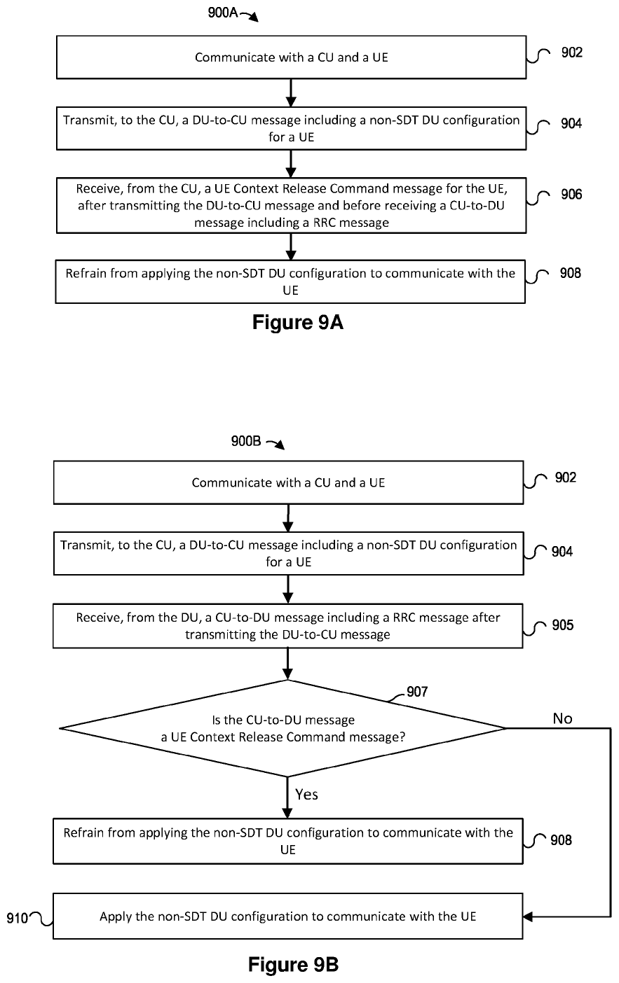

FIG. 9A illustrates a method 900A, implemented by a DU (e.g., the DU 174), for providing SDT configuration parameters to a UE (e.g., the UE 102) via a CU (e.g., the CU 172 or the CU-CP 172A).

The method 900A begins at block 902, where the DU communicates with the CU and the UE (e.g., events 304, 306, 318, 310, 312, 316, 314, 318, 390, 320, 321, 322, 404, 406, 408, 410, 415, 416, 418, 494, 420, 421, 422 of FIGS. 3 and 4). At block 904, the DU transmits, to the CU, a DU-to-CU message including a non-SDT DU configuration for a UE (e.g., events 308, 330, 430). At block 906, the DU receives, from the CU, a UE Context Release Command message for the UE after transmitting the DU-to-CU message and before receiving a CU-to-DU message including an RRC message (e.g., events 332, 432 of FIGS. 3 and 4). At block 908, the DU refrains from applying the non-SDT DU configuration to communicate with the UE.

FIG. 9B is a flow diagram of an example method 900B similar to the method 900A, except that method 900B includes blocks 905, 907, and 910 instead of block 906. At block 905, the DU receives, from the DU, a CU-to-DU message including an RRC message after transmitting the DU-to-CU message (e.g., events 308, 332, 338, 438, 432 of FIGS. 3 and 4). At block 907, the DU determines whether the CU-to-DU message is a UE Context Release Command message (i.e., a CU-to-DU message releasing a UE Context of the UE). If the DU determines that the CU-to-DU message is a UE Context Release Command message, the flow proceeds to block 908. Otherwise, if the DU determines that the CU-to-DU message is not a UE Context Release Command message, the flow proceeds to block 910. At block 910, the DU applies the non-SDT DU configuration to communicate with the UE (e.g., event 318 of FIG. 3).

Examples and implementations described for FIGS. 3, 4, 5A-5D, 6A-6F, 7, and 8A-8B can apply to FIGS. 9A and 9B.

The following description may be applied to the description above.

Generally speaking, description for one of the above figures can apply to another of the above figures. An event or block described above can be optional or omitted. For example, an event or block with dashed lines in the figures can be optional or omitted. In some cases, an event or block with solid lines in the figures can still be optional or omitted if the event or block is not necessary. In some implementations, a “message” (as the term is used above) can be replaced by “information element (IE),” and vice versa. In some implementations, an “IE” (as the term is used above) can be replaced by “field,” and vice versa. In some implementations, a “configuration” (as the term is used above) can be replaced by “configurations” or “configuration parameters,” and vice versa. In some implementations, “small data transmission” (as the term is used above) can be replaced by “early data transmission” (and “SDT” can be replaced by “EDT”), and vice versa. In some implementations, “small data transmission” (as the term is used above) can be replaced by “small data communication,” and vice versa. In some implementations, “stop” (as the term is used above) can be replaced by “suspend.”

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method implemented in a central unit (CU) of a distributed base station that also includes a distributed unit (DU), the method comprising:
receiving, from the DU, (i) a small data transmission (SDT) configuration related to SDT and (ii) a non-SDT configuration related to non-SDT operation, the non-SDT configuration including a cell group configuration;
providing the SDT configuration to a UE; and
ignoring, at the CU, the non-SDT configuration.

2. The method of claim 1, further comprising:
transmitting, to the DU and prior to the receiving of the SDT configuration, a request for the SDT configuration.

3. The method of claim 2, wherein:
the transmitting of the request to the DU includes transmitting a UE Context Modification Request message; and
the receiving of the SDT configuration includes receiving a UE Context Modification Response message.

4. The method of claim 2, wherein:
the ignoring in response to the transmitting the request for the SDT configuration.

5. The method of claim 1, wherein the providing of the SDT configuration to the UE includes:
transmitting, to the DU, a first command to release a context for the UE, the first command including a second command to release a radio connection.

6. The method of claim 5, wherein the transmitting includes:
transmitting, to the UE via the DU, the second command to release the radio connection, the second command including the SDT configuration.

7. The method of claim 6, wherein the cell group configuration includes a CellGroupConfig IE.

8. The method of claim 1, wherein the SDT configuration includes a configured grant SDT (CG-SDT) configuration.

9. The method of claim 1, wherein the receiving (i) the SDT configuration and (ii) the non-SDT configuration includes receiving the SDT configuration and the non-SDT configuration in a DU to CU RRC Information IE. 10 (Currently Amended) The method of claim 1, wherein:
the SDT configuration includes a configured scheduling radio network temporary identifier (CS-RNTI).

11. The method of claim 1, wherein:
the SDT configuration includes a ConfiguredGrantConfig IE.

12. The method of claim 1, wherein:
the SDT configuration includes a time alignment value.

13. The method of claim 1, wherein:
the SDT configuration includes a timing advance validity threshold.

14. A central unit (CU) of a distributed base station, the CU comprising processing hardware and configured to:
receive, from a distributed unit (DU) of the distributed base station, (i) a small data transmission (SDT) configuration related to SDT and (ii) a non-SDT configuration related to non- SDT operation, the non-SDT configuration including a cell group configuration;
provide the SDT configuration to a UE; and
ignore, at the CU, the non-SDT configuration.

15. (canceled)

16. The CU of claim 14, further configured to:
transmit, to the DU and prior to the receiving of the SDT configuration, a request for the SDT configuration.

17. The CU of claim 16, wherein:
to transmit the request to the DU, the CU is configured to transmit a UE Context Modification Request message; and
to receive the SDT configuration, the CU is configured to receive a UE Context Modification Response message.

18. The CU of claim 16, wherein:
the CU is configured to ignore the non-SDT configuration in response to the transmitting the request for the SDT configuration.

19. The CU of claim 16, wherein to provide the SDT configuration, the CU is configured to:
transmit, to the DU, a first command to release a context for the UE, the first command including a second command to release a radio connection.

20. The CU of claim 14, wherein:
the SDT configuration includes a configured grant SDT (CG-SDT) configuration.

21. The CU of claim 14, wherein to receive (i) the SDT configuration and (ii) the non-SDT configuration, the CU is configured to:
receive the SDT configuration and the non-SDT configuration in a DU to CU RRC Information IE.
